(19) United States
(12) Patent Application Publication
(10) Pub. No.: US 2010/0022294 A1
(43) Pub. Date: Jan. 28, 2010

(54) SLOT MACHINE

(75) Inventor: Kazumasa Yoshizawa, Koto-ku (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Aruze Corp., Koto-ku (JP)

(21) Appl. No.: 12/499,201

(22) Filed: Jul. 8, 2009

Related U.S. Application Data
(60) Provisional application No. 61/136,075, filed on Aug. 11, 2008.
(60) Provisional application No. 61/083,758, filed on Jul. 25, 2008.

(51) Int. Cl. A63F 9/24; A63F 13/00

(52) U.S. Cl. 463/20; 463/25; 463/30

(57) ABSTRACT

A slot machine according to the present invention is constituted to: scroll-display plural types of symbols in a first direction; determine wining establishment of a special prize in a case where a plurality of pieces drawn as a background of the symbols rearranged on a display device are displayed in combination making up a first picture; scroll-display the plural types of symbols in a second direction; determine type of the special prize depending on a second picture in a case where it is determined that the plurality of pieces drawn as the background of the symbols rearranged on the display device make up the second picture; and execute a process of awarding the special prize based upon the determined type of special prize.

### CROSS-REFERENCE TO RELATED APPLICATIONS

This application claims priority of U.S. Provisional Application No. 61/136,075 filed on Aug. 11, 2008 and U.S. Provisional Application No. 61/083,758 filed on Jul. 25, 2008. The contents of these applications are incorporated herein by reference in their entirety.

### BACKGROUND OF THE INVENTION

1. Field of the Invention

The present invention relates to a slot machine.

2. Description of the Related Art

Conventionally, slot machines known as type of gaming machines are constituted so as to: start games by players inserting coins or the like into the gaming machine; variably display columns of symbols in predetermined regions of the gaming machine while they are displayed in a stopped state after a predetermined period has elapsed; and award a payout based upon a combination of symbols displayed in a stopped state.

In addition, the above slot machines are generally constituted to judge whether or not a winning combination allowed to award any of payouts is established, based upon whether or not the predetermined number of symbols of the same type (for example, “CHERRY” or “7”) are arranged along a preset payline. In the conventional slot machine, in a case where the predetermined number or more of symbols of the same type are arranged, it has been a common routine to award a payout based upon the number of the aforementioned arranged symbols, regardless of the payout line.

Further, many of the conventional slot machines have been known which conduct two types of games, i.e., a basic game and a free game. The basic game is executed upon consumption of gaming values (such as coins or credits) corresponding to the bet amount. On the other hand, the free game is executed without consuming gaming values corresponding to the bet amount.

The basic game is switched to the free game when a predetermined condition is satisfied. The condition includes a case in which, for example, a specific symbol is displayed in a stopped state during the basic game. The free game is switched to the basic game when a predetermined condition is satisfied. The condition includes a case in which, for example, the free games are executed a predetermined number of times.

In the conventional slot machines, it has been a common routine to raise players' expectations for the free game by changing arrangement of symbols during the free game differently from that during the basic game. For example, U.S. Pat. No. 6,394,902-B2 describes a slot machine in which a total of fifteen symbols are displayed in three rows and five columns with the use of video reels. This slot machine changes symbol columns arranged on reels during the free game differently from that during the basic game, in which eight types of symbols are decreased to five. In this manner, the probability of awarding a payout can be apparently increased during the free game.

With such a slot machine, players are caused to raise their interest and concern relevant to a game by setting a combination set for a prize to be formed in a case where the predetermined number of symbols of the same type are arranged along not a preset payline but various paylines. For example, U.S. Pat. No. 6,604,999-B2 describes a slot machine that provides various patterns of paylines by which players can be amused.

In the aforementioned conventional slot machines, however, irrespective of whichever of the basic game and the free game is in progress, the symbols of different types have been randomly arranged in combination and sequential order. These slot machines determine the contents of the prize to be awarded, based upon a combination of multiple symbols that have been arranged in a display device. Therefore, players have expectations only for random payout based upon a combination of plural types of symbols that have been randomly arranged in the display device. Thus, the slot machines can neither notify players of status a FEATURE IN state of free game by means of a clear image nor clearly report by visible expression, to players information as to in what state a free game is started. Accordingly, a need exists for the advent of slot machines with new entertainability, which can allow players to quickly understand the FEATURE IN state of a free game or the like.

Thus, the present invention has been made in view of the above-described circumstance. It is an object of the present invention to provide a novel slot machine that is improved in entertainability associated with arrangement of the symbols so as to report the FEATURE IN state of the free game to players in a clearly understandable manner, which greatly enhances players' understanding.

### SUMMARY OF THE INVENTION

An aspect of the present invention is a slot machine including (i) a display device for displaying plural types of symbols and a plurality of partial pieces making up a single picture drawn as a background of the symbols; (ii) a memory for storing image data concerning the plurality of pieces making up a first picture, and image data concerning the plurality of pieces making up a second picture; and (iii) a controller. The controller is programmed to: (a) determine the plural types of symbols to be rearranged on the display device; (b) read out of the memory, the plural types of symbols and the image data concerning the plurality of pieces making up the first picture, according to a result of the determination in the itemized (a); (c) rearrange on the display device, the plural types of symbols read out in the itemized (b), and the image data concerning the plurality of pieces making up the first picture drawn as the background of the symbols; (d) award a payout based upon a predetermined combination, in a case where a judgment that the symbols rearranged on the display device establish the predetermined combination is made as a result of the itemized (c); (e) determine winning establishment of a special prize, in a case where a judgment that the plurality of pieces drawn as the background of the symbols rearranged on the display device are combined with one another on the display device to make up the first picture is made as a result of the itemized (c); (f) read out of the memory, the plural types of symbols and the image data concerning the plurality of pieces making up the second picture; and (g) rearrange on the display device, the plural types of symbols read out in the itemized (f), and the image data concerning the plurality of pieces making up the second picture drawn as the background of the symbols.

According to the aforementioned aspect, the controller is further programmed to: rearrange on the display device in the itemized (c), the plural types of symbols and the image data concerning the plurality of pieces making up the first picture so as to variably display in a first direction, a symbol array having the plurality of pieces making up the first picture drawn as the background of the plural types of symbols; rearrange on the display device in the itemized (g), the plural types of symbols and the image data concerning the plurality of pieces making up the second picture so as to variably display in a second direction, a symbol array having the plurality of pieces drawn as the background of the plural types of symbols; determine type of the special prize in accordance with the second picture, in a case where a judgment that the plurality of pieces making up the second picture rearranged on the display device are combined with one another on the display device to make up the second picture is made; and execute a process of awarding the determined special prize.

According to the aforementioned aspect, processes in the itemized (f) and (g) are executed during the special prize determined in the itemized (e); and the controller is further programmed to award a special payout in a case where a judgment that the plurality of pieces making up the second picture drawn as the background of the symbols are combined with one another on the display device to make up the second picture is made as a result of repeated execution of the itemized (f) and (g) during the special prize.

An aspect of the present invention is a slot machine including: (i) a display device for displaying plural types of symbols and a plurality of partial pieces making up a single picture drawn as a background of the symbols; (ii) a memory for storing image data concerning the plurality of pieces making up a first picture intended for determining winning establishment of a special prize, and image data concerning the plurality of pieces making up a second picture intended for determining type of the special prize; and (iii) a controller. The controller is programmed to: (a) read out of the memory, the image data concerning the plurality of pieces making up the first picture; (b) variably display in a first direction, a symbol array having at least one of the plurality of pieces drawn as the background of the symbols; (c) award a payout based upon a predetermined combination, in a case where a judgment that the symbols rearranged on the display device establish the predetermined combination is made as a result of the itemized (b); (d) determine the winning establishment of the special prize, in a case where a judgment that the plurality of pieces drawn as the background of the symbols rearranged on the display device are combined with one another on the display device to make up the first picture is made as a result of the itemized (b); (e) read out of the memory, the image data concerning the plurality of pieces making up the second picture; (f) variably display in a second direction different from the first direction, a plurality of symbol arrays having the plurality of pieces drawn thereon; (g) determine the type of the special prize in accordance with the second picture, in a case where a judgment that the plurality of pieces rearranged on the display device are combined with one another on the display device to make up the second picture is made as a result of the itemized (f); and (h) execute a process of awarding the special prize based upon the special prize of the type determined in the itemized (g).

According to the aforementioned slot machine, display of the first and second pictures enables players to visually specify winning establishment and type of the special prize. Therefore, the aforementioned aspect greatly enhances players' understanding of game contents. Furthermore, the plural types of symbols having the first picture and those having the second picture are variably displayed in opposite directions. Thus, the players can be notified of determination of winning establishment and type of the special prize in a visibly understandable manner.

An aspect of the present invention is a slot machine constituted as set forth below. In the aforementioned aspect, the second picture is made up of a plurality of pictures in accordance with the type of the special prize.

According to the aforementioned slot machine, the second picture includes a plurality of pictures corresponding to types of a special prize, which enables the player to easily specify type of the special prize.

An aspect of the present invention is a slot machine constituted as set forth below. In the aforementioned aspect, the controller executes a process in the itemized (f) such that the plurality of pieces making up the second picture are drawn in at least three or more symbol arrays.

An aspect of the present invention enhances players' visibility until when the second picture is combined.

An aspect of the present invention is a slot machine constituted as set forth below. In the aforementioned aspect, the controller adjusts luminance of the display device so as to display with relatively high luminance a region of the display device in which the second picture is arranged, in a case where a judgment that the plurality of pieces are combined with one another on the display device to make up the second picture is made in the itemized (g).

An aspect of the present invention enables players to be notified that the second picture is displayed, in a visibly understandable manner.

An aspect of the present invention is a slot machine including: (i) a display device for displaying plural types of symbols and a plurality of partial pieces making up a single picture drawn as a background of the symbols; (ii) a memory for storing image data concerning the plurality of pieces making up a first picture intended for determining winning establishment of a special prize, and image data concerning the plurality of pieces making up a second picture intended for determining type of the special prize; and (iii) a controller. The controller is programmed to: (a) read out of the memory, the image data concerning the plurality of pieces making up the first picture; (b) variably display in a first direction, a symbol array having at least one of the plurality of pieces drawn as the background of the symbols; (c) award a payout based upon a predetermined combination, in a case where a judgment that the symbols rearranged on the display device establish the predetermined combination is made as a result of the itemized (b); (d) determine the winning establishment of the special prize, in a case where a judgment that the plurality of pieces drawn as the background of the symbols rearranged on the display device are combined with one another on the display device to make up the first picture is made as a result of the itemized (b); (e) read out of the memory, the image data concerning the plurality of pieces making up the second picture; (f) variably display in a second direction different from the first direction, at least three or more symbol arrays having the plurality of pieces drawn thereon; (g) determine the type of the special prize in accordance with the second picture, in a case where a judgment that the plurality of pieces rearranged on the display device are combined with one another on the display device to make up the second picture is made as a result of the itemized (f); and (h) execute a process of awarding the special prize based upon the special prize of the type determined in the itemized (g).

According to the aforementioned slot machine, display of the first and second pictures enables players to visibly specify winning establishment and type of the special prize. Therefore, the aforementioned aspect greatly enhances players' understanding of game contents. Furthermore, the plural types of symbols having the first picture and those having the second picture are scroll-displayed in opposite directions. Thus, the players can be notified of determination of winning establishment and type of the special prize in a visibly understandable manner.

An aspect of the present invention is a slot machine constituted as set forth below. In the aforementioned aspect, the second picture is made up of a plurality of pictures in accordance with the type of the special prize.

According to the aforementioned slot machine, the second picture includes a plurality of pictures corresponding to types of a special prize, which enables the player to easily specify type of the special prize.

An aspect of the present invention is a slot machine constituted as set forth below. In the aforementioned aspect, the controller adjusts luminance of the display device so as to display with relatively high luminance a region of the display device in which the second picture is arranged, in a case where a judgment that the plurality of pieces are combined with one another on the display device to make up the second picture is made in the itemized (g).

An aspect of the present invention enables players to be notified that the second picture is displayed, in a visibly understandable manner.

An aspect of the present invention is a slot machine including: (i) a display device for displaying plural types of symbols and a plurality of partial pieces making up a single picture drawn as a background of the symbols; (ii) a memory for storing image data concerning the plurality of pieces making up a first picture intended for determining winning establishment of a special prize, and image data concerning the plurality of pieces making up a second picture intended for determining type of the special prize; and (iii) a controller. The controller is programmed to: (a) read out of the memory, the image data concerning the plurality of pieces making up the first picture; (b) variably display in a first direction, a symbol array having at least one of the plurality of pieces drawn as the background of the symbols; (c) award a payout based upon a predetermined combination, in a case where a judgment that the symbols rearranged on the display device establish the predetermined combination is made as a result of the itemized (b); (d) determine the winning establishment of the special prize, in a case where a judgment that the plurality of pieces drawn as the background of the symbols rearranged on the display device are combined with one another on the display device to make up the first picture is made as a result of the itemized (b); (e) read out of the memory, the image data concerning the plurality of pieces making up the second picture; (f) variably display in a second direction different from the first direction, a plurality of symbol arrays in which the plurality of pieces are drawn; (g) determine the type of the special prize in accordance with the second picture and display with relatively high luminance a region of the display device in which the second picture is arranged, in a case where a judgment that the plurality of pieces rearranged on the display device are combined with one another on the display device to make up the second picture is made as a result of the itemized (f); and (h) execute a process of awarding the special prize based upon the special prize of the type determined in the itemized (g).

According to the aforementioned slot machine, display of the first and second pictures enables players to visually specify winning establishment and type of the special prize. Therefore, the aforementioned aspect greatly enhances players' understanding of game contents. Furthermore, the plural types of symbols having the first picture and those having the second picture are variably displayed in opposite directions. Thus, the players can be notified of determination of winning establishment and type of the special prize in a visibly understandable manner.

An aspect of the present invention is a slot machine constituted as set forth below. In the aforementioned aspect, the second picture is made up of a plurality of pictures in accordance with the type of the special prize.

According to the aforementioned slot machine, a plurality of pictures corresponding to types of a special prize, which enables the player to easily specify type of the special prize.

An aspect of the present invention is a slot machine consisted as set forth below. In the aforementioned aspect, the controller executes a process in the itemized (f) such that the plurality of pieces making up the second picture are drawn in at least three or more symbol arrays.

An aspect of the present invention enhances players' visibility until when the second picture is combined.

An aspect of the present invention is a slot machine including: (i) a plurality of mechanical reels on which plural types of symbols are drawn; (ii) a liquid crystal display device disposed on front surfaces of the plurality of mechanical reels so as to transparently display the symbols and a plurality of partial pieces making up a single picture are drawn as a foreground of the symbols; (iii) a memory for storing image data concerning the plurality of pieces making up a first picture intended for determining winning establishment of a special prize, and image data concerning the plurality of pieces making up a second picture intended for determining type of the special prize; and (iv) a controller. The controller is programmed to: (a) read out of the memory, the image data concerning the plurality of pieces making up the first picture; (b) variably display the plurality of mechanical reels in a first direction; (c) variably display the plurality of pieces in the first direction on the liquid crystal display device; (d) award a payout based upon a predetermined combination, in a case where a judgment that the symbols rearranged on the liquid crystal display device establish the predetermined combination is made; (e) determine the winning establishment of the special prize, in a case where a judgment that the plurality of pieces drawn as the foreground of the symbols rearranged on the liquid crystal display device are combined with one another to make up the first picture is made; (f) read out of the memory, the image data concerning the plurality of pieces making up the second picture; (g) variably display in a second direction different from the first direction, the plurality of pieces on the liquid crystal display device; (h) determine the type of the special prize in accordance with the second picture, in a case where a judgment that the plurality of pieces rearranged on the liquid crystal display device are combined with one another on the liquid crystal display device to make up the second picture is made; and (i) execute a process of awarding the special prize based upon the special prize of the type determined in the itemized (h).

According to the aforementioned slot machine, display of the first and second pictures enables players to visually specify winning establishment and type of the special prize. Therefore, the aforementioned aspect greatly enhances players' understanding of game contents. Furthermore, the plural types of symbols having the first picture and those having the second picture are variably displayed in opposite directions. Thus, the players can be notified of determination of winning establishment and type of the special prize in a visibly understandable manner.

An aspect of the present invention is a slot machine including: (i) a display device for displaying plural types of symbols and a plurality of background images which are drawn as backgrounds of the symbols and make up a single complete image; and (ii) a controller. The controller is configured to: (a) determine the plural types of symbols to be rearranged on the display device; (b) rearrange on the display device, the plural types of symbols determined in the itemized (a) and the plurality of background images drawn as the backgrounds of the symbols; (c) award a payout based on the symbols rearranged on the display device, in a case where the symbols form a predetermined combination as a result of the itemized (b); (d) judge whether or not the plurality of background images drawn as the backgrounds of the symbols that have been rearranged on the display device as a result of the itemized (b) are displayed in combination making up the single complete image; (e) execute a special game as a special prize, in a case where a judgment is made as a result of the itemized (d), that the plurality of background images drawn as the backgrounds of the symbols make up the single complete image; and (f) award a special payout, in a case where a judgment is made as a result of the itemized (a) to (d) processed during the special game executed in the itemized (e), that the plurality of background images drawn as the backgrounds of the symbols are displayed in combination making up the single complete image on the display device.

According to the aforementioned slot machine, a basic game is terminated and a free game is then executed in a case where the rearranged background images display the complete image during the basic game. The special payout is awarded in a case where the rearranged background images display the complete image during the free game. Therefore, a novel slot machine can be provided that is improved in its entertainability associated with arrangement of symbols and can report a FEATURE IN state of the free game, for example, to players in a clearly understandable manner, which greatly enhances players' understanding.

An aspect of the present invention is a slot machine constituted as set forth below. In the aforementioned aspect, the slot machine further includes an image memory for storing the plurality of background images making up a first complete image and the plurality of background images making up a second complete image. The controller: reads out the plurality of background images making up the first complete image from the image memory; displays the read-out plurality of background images making up the first complete image, as the backgrounds of the symbols, in the itemized (b) to (e); reads out the plurality of background images making up the second complete image from the image memory; and displays the read-out plurality of background images making up the second complete image, as the background of the symbols, in the itemized (f).

According to the aforementioned slot machine, the rearranged background images are different between the basic game and the free game, so that the slot machine can report the FEATURE IN state to players in a clearly understandable manner, which greatly enhances players' understanding.

An aspect of the present invention is a slot machine constituted as set forth below. In the aforementioned aspect, the controller, in a case where the plurality of background images are displayed in combination making up the single complete image on the display device in the itemized (f): randomly determines rank of the special payout; and awards the special payout based on the determined rank.

According to the aforementioned slot machine, the slot machine randomly determines rank of the special payout in a case where the background images rearranged in the image display region display the complete image during the free game. Therefore, the slot machine can be improved in its entertainability.

An aspect of the present invention is a slot machine constituted as set forth below. In the aforementioned aspect, the controller, in the itemized (f): randomly determines a predetermined multiple number to increase a payout during the special game; and awards the payout based on the predetermined multiple number, in a case where the symbols rearranged on the display device form a predetermined combination.

According to the aforementioned slot machine, the slot machine determines a multiple number used to increase a payout during the free game, and awards a payout determined by multiplying a predetermined payout by the determined multiple number in a case where the rearranged symbols form a predetermined combination during the free game. For example, the multiple number to increase a payout is determined as five and the symbols in a predetermined combination are rearranged during the free game, the slot machine awards a payout five times higher than that corresponding to the predetermined combination. Therefore, the slot machine can be improved in its entertainability associated with arrangement of symbols.

An aspect of the present invention is a slot machine constituted as set forth below. In the aforementioned aspect, the controller, in the itemized (e) and (f), adjusts display luminance of the display device to display with relatively high luminance a region of the display device in which the single complete image is displayed, in a case where the plurality of background images are displayed in combination making up the single complete image on the displace device.

According to the aforementioned slot machine, the rearranged background images are different between the basic game and the free game, so that the slot machine can report the FEATURE IN state to players in a clearly understandable manner, which greatly enhances players' understanding.

An aspect of the present invention is a slot machine including: (i) a display device for displaying plural types of symbols and a plurality of background images which are drawn as backgrounds of the symbols and make up a single complete image; (ii) an image memory for storing the plurality of background images making up a first complete image and the plurality of background images making up a second complete image; and (iii) a controller. The controller is configured to: (a) determine the plural types of symbols to be rearranged on the display device; (b) read out the plurality of background images making up the first complete image from the image memory; (c) rearrange on the display device, the plural types of symbols determined in the itemized (a) and the plurality of background images that are drawn as the backgrounds of the symbols and make up the first complete image; (d) award a payout based on the symbols rearranged on the display device, in a case where the symbols form a predetermined combination as a result of the itemized (c); (e) judge whether or not the plurality of background images drawn as the backgrounds of the symbols that have been rearranged on the display device as a result of the itemized (c) are displayed in combination making up the single first complete image; (f) execute a special game as a special prize, in a case where a judgment is made as a result of the itemized (e), that the plurality of background images drawn as the backgrounds of the symbols make up the single first complete image; (g) read out from the image memory the plurality of background images making up the second complete image during the special game executed in the itemized (f); and (h) award a special payout, in a case where a judgment is made as a result of the itemized (a) to (e) processed during the special game executed in the itemized (f), that the plurality of background images drawn as the backgrounds of the symbols are displayed in combination making up the single second complete image on the display device.

According to the aforementioned slot machine, the basic game is terminated and the free game is then executed in a case where the rearranged background images display the complete image during the basic game. The special payout is awarded in a case where the rearranged background images display the complete image during the free game. Therefore, a novel slot machine can be provided that is improved in its entertainability associated with arrangement of symbols and can report a FEATURE IN state of the free game, for example, to players in a clearly understandable manner, which greatly enhances players' understanding. Furthermore, the rearranged background images are different between the basic game and the free game, so that the slot machine can report the FEATURE IN state to players in a clearly understandable manner, which greatly enhances players' understanding.

An aspect of the present invention is a slot machine constituted as set forth below. In the aforementioned aspect, the controller, in a case where the plurality of background images are displayed in combination making up the single complete image on the display device in the itemized (h): randomly determines rank of the special payout; and awards the special payout based on the determined rank.

According to the aforementioned slot machine, the slot machine randomly determines rank of the special payout and awards the payout in a case where the background images rearranged in the image display region display the complete image during the free game. Therefore, the slot machine can be improved in its entertainability.

An aspect of the present invention is a slot machine constituted as set forth below. In the aforementioned aspect, the controller, in the itemized (h): randomly determines a predetermined multiple number to increase a payout during the special game; and awards the payout based on the predetermined multiple number, in a case where the symbols rearranged on the display device form a predetermined combination.

According to the aforementioned slot machine, the slot machine determines a multiple number used to increase a payout during the free game, and awards a payout determined by multiplying a predetermined payout by the determined multiple number in a case where the rearranged symbols form a predetermined combination during the free game. For example, the multiple number to increase a payout is determined as five and the symbols in a predetermined combination are rearranged during the free game, the slot machine awards a payout five times higher than that corresponding to the predetermined combination. Therefore, the slot machine can be improved in its entertainability associated with arrangement of symbols.

An aspect of the present invention is a slot machine constituted as set forth below. In the aforementioned aspect, the controller, in the itemized (e) and (f), adjusts display luminance of the display device to display with relatively high luminance a region of the display device in which the single complete image is displayed, in a case where the plurality of background images are displayed in combination making up the single complete image on the displace device.

According to the aforementioned slot machine, the rearranged background images are different between the basic game and the free game, so that the slot machine can report the FEATURE IN state to players in a clearly understandable manner, which greatly enhances players' understanding

An aspect of the present invention is a slot machine including (i) a display device for displaying plural types of symbols and a plurality of background images which are drawn as backgrounds of the symbols and make up a single complete image; and (ii) a controller. The controller is configured to: (a) determine the plural types of symbols to be rearranged on the display device; (b) rearrange on the display device, the plural types of symbols determined in the itemized (a) and the plurality of background images drawn as the backgrounds of the symbols; (c) award a payout based on the symbols rearranged on the display device, in a case where the symbols form a predetermined combination as a result of the itemized (b); (d) judge whether or not the plurality of background images drawn as the backgrounds of the symbols that have been rearranged on the display device as a result of the itemized (b) are displayed in combination making up the single complete image; (e) execute a special game as a special prize, in a case where a judgment is made as a result of the itemized (d), that the plurality of background images drawn as the backgrounds of the symbols make up the single complete image; (f) randomly determine rank of a special payout, in a case where a judgment is made as a result of the itemized (a) to (d) processed during the special game executed in the itemized (e), that the plurality of background images drawn as the backgrounds of the symbols are displayed in combination making up the single complete image on the display device; and (g) award the special payout based on the rank determined in the itemized (f).

According to the aforementioned slot machine, the basic game is terminated and the free game is then executed in a case where the rearranged background images display the complete image during the basic game. The special payout is awarded in a case where the rearranged background images display the complete image during the free game. Therefore, a novel slot machine can be provided that is improved in its entertainability associated with arrangement of symbols and can report a FEATURE IN state of the free game, for example, to players in a clearly understandable manner, which greatly enhances players' understanding. Furthermore, the slot machine randomly determines rank of the special payout and awards the payout in a case where the background images rearranged in the image display region display the complete image during the free game. Therefore, the slot machine can be improved in its entertainability.

An aspect of the present invention is a slot machine constituted as set forth below. In the aforementioned aspect, the slot machine further includes an image memory for storing the plurality of background images making up a first complete image and the plurality of background images making up a second complete image. The controller: reads out the plurality of background images making up the first complete image from the image memory; displays the read-out plurality of background images making up the first complete image, as the backgrounds of the symbols, in the itemized (b) to (e); reads out the plurality of background images making up the second complete image from the image memory; and displays the read-out plurality of background images making up the second complete image, as the background of the symbols, in the itemized (f).

According to the aforementioned slot machine, the rearranged background images are different between the basic game and the free game, so that the slot machine can report the FEATURE IN state to players in a clearly understandable manner, which greatly enhances players' understanding.

An aspect of the present invention is a slot machine constituted as set forth below. In the aforementioned aspect, the controller, in the itemized (f): randomly determines a predetermined multiple number to increase a payout during the special game; and awards the payout based on the predetermined multiple number, in a case where the symbols rearranged on the display device form a predetermined combination.

According to the aforementioned slot machine, the slot machine determines a multiple number used to increase a payout during the free game, and awards a payout determined by multiplying a predetermined payout by the determined multiple number in a case where the rearranged symbols form a predetermined combination during the free game. For example, the multiple number to increase a payout is determined as five and the symbols in a predetermined combination are rearranged during the free game, the slot machine awards a payout five times higher than that corresponding to the predetermined combination. Therefore, the slot machine can be improved in its entertainability associated with arrangement of symbols.

An aspect of the present invention is a slot machine constituted as set forth below. In the aforementioned aspect, the controller, in the itemized (e) and (f), adjusts display luminance of the display device to display with relatively high luminance a region of the display device in which the single complete image is displayed, in a case where the plurality of background images are displayed in combination making up the single complete image on the displace device.

According to the aforementioned slot machine, the rearranged background images are different between the basic game and the free game, so that the slot machine can report the FEATURE IN state to players in a clearly understandable manner, which greatly enhances players' understanding.

### BRIEF DESCRIPTION OF THE DRAWINGS

FIGS. 1A and 1B are views each showing an exemplary display screen according to the first embodiment;

FIG. 2 is a perspective view schematically showing a slot machine according to the first embodiment;

FIG. 3 is a view depicting an internal configuration of the slot machine according to the first embodiment;

FIGS. 4A and 4B are tables illustrating a first picture and a second picture according to the first embodiment;

FIGS. 5A and 5B are views each showing an exemplary display screen displayed during a basic game according to the first embodiment;

FIGS. 6A to 6C are views each showing a symbol array on a second column making up the first picture according to the first embodiment;

FIGS. 7A to 7C are views each showing a symbol array on a third column making up the first picture according to the first embodiment;

FIGS. 8A to 8C are views each showing a symbol array on a fourth column making up the first picture according to the first embodiment;

FIGS. 9A and 9B are views each showing an exemplary display screen displayed during a basic game according to the first embodiment;

FIGS. 10A and 10B are views each showing an exemplary display screen displayed during the basic game according to the first embodiment;

FIG. 11 is a view showing a symbol array on a first row making up the second picture according to the first embodiment;

FIG. 12 is a view showing a symbol array on a second row making up the second picture according to the first embodiment;

FIG. 13 is a view showing a symbol array on a third row making up the second picture according to the first embodiment;

FIGS. 14A and 14B are views each showing an exemplary display screen displayed during a free game according to the first embodiment;

FIG. 15 is a flowchart showing a subroutine of a main process according to the first embodiment;

FIG. 16 is a flowchart showing a subroutine of a game execution process according to the first embodiment;

FIG. 17 is a flowchart showing a subroutine of a free game execution process according to the first embodiment;

FIG. 18 is a flowchart showing a free game number determination process according to the first embodiment;

FIGS. 19A and 19B are views each showing an exemplary display screen according to an embodiment of the present invention according to the second embodiment;

FIG. 20 is a perspective view schematically showing a frame format of a slot machine according to the embodiment of the present invention according to the second embodiment;

FIG. 21 is a view showing an internal construction of the slot machine shown in FIG. 20 according to the second embodiment;

FIGS. 22A and 22B are views each showing an exemplary image displayed during a basic game according to the second embodiment;

FIGS. 23A to 23C are views each showing a symbol array on a second column during a free game according to the second embodiment;

FIGS. 24A to 24C are views each showing a symbol array on a third column during the free game according to the second embodiment;

FIGS. 25A to 25C are views each showing a symbol array on a fourth column during the free game according to the second embodiment;

FIGS. 26A and 26B are views each showing an exemplary display screen displayed during the free game according to the second embodiment;

FIGS. 27A and 27B are views each showing an exemplary display screen displayed during the free game according to the second embodiment;

FIGS. 28A and 28B are views each showing an exemplary display screen displayed during the free game according to the second embodiment;

FIGS. 29A and 29B are views each showing an exemplary display screen during a jackpot bonus game according to the second embodiment;

FIGS. 30A and 30B are views each showing an exemplary display screen during the jackpot bonus game according to the second embodiment;

FIG. 31 is a flowchart showing a subroutine of the main process according to the second embodiment;

FIG. 32 is a flowchart showing a subroutine of a game execution process according to the second embodiment;

FIG. 33 is a flowchart showing a subroutine of a free game execution process according to the second embodiment;

FIG. 34 is a flowchart showing a subroutine of a jackpot bonus game execution process according to the second embodiment;

FIG. 35 is a perspective view schematically showing a frame format of a slot machine according to another embodiment of the present invention according to the second embodiment; and

FIG. 36 is a view showing reels of the slot machine shown in FIG. 35.

### DESCRIPTION OF THE PREFERRED EMBODIMENTS

### First Embodiment

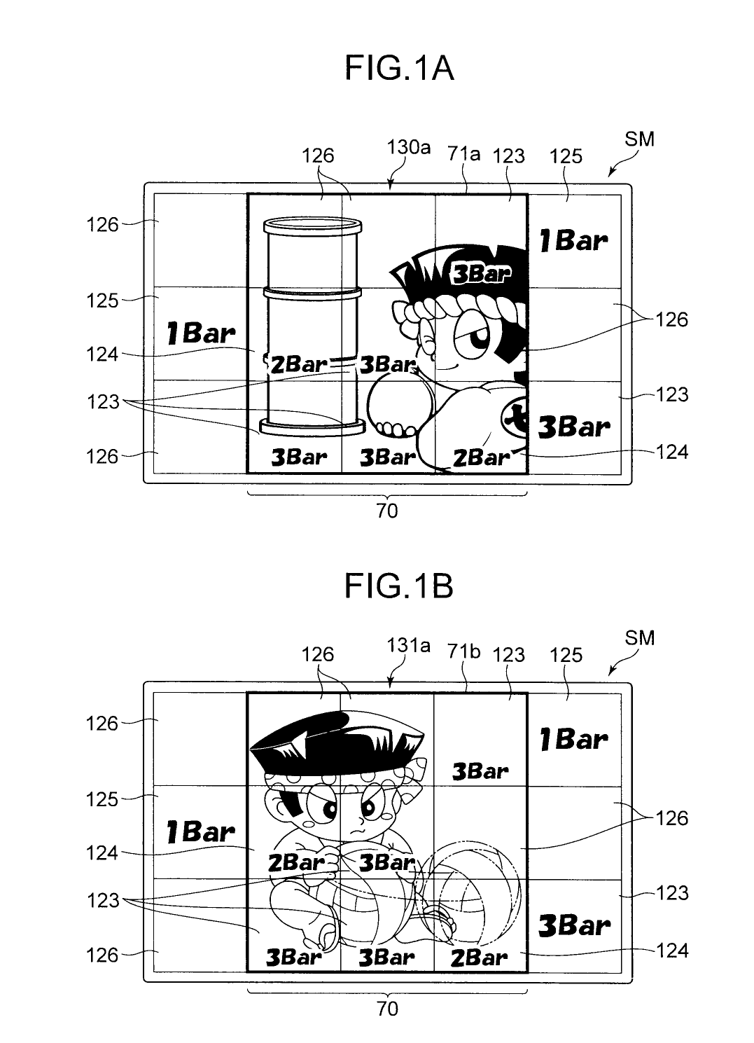

First, a slot machine 10 according to an embodiment of the present invention will be described with reference to the drawings. FIGS. 1A and 1B are views each showing an exemplary display screen according to this embodiment. As shown in FIGS. 1A and 1B, a display device included in the slot machine 10 displays plural types of symbols and a plurality of partial pieces making up a single picture, drawn as a background of the symbols.

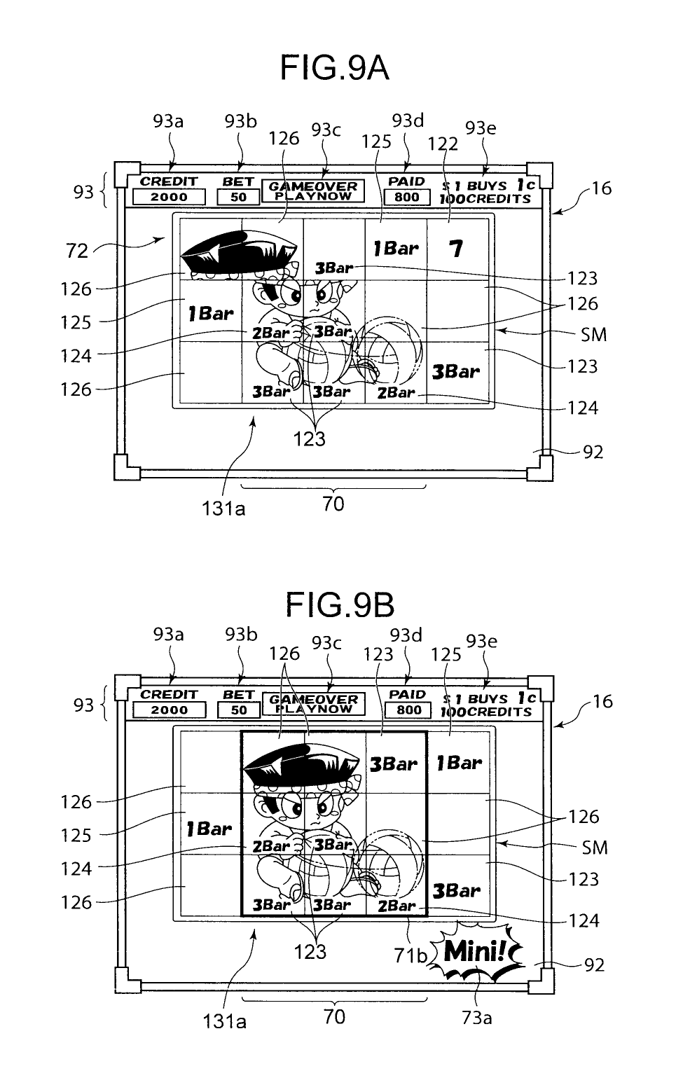

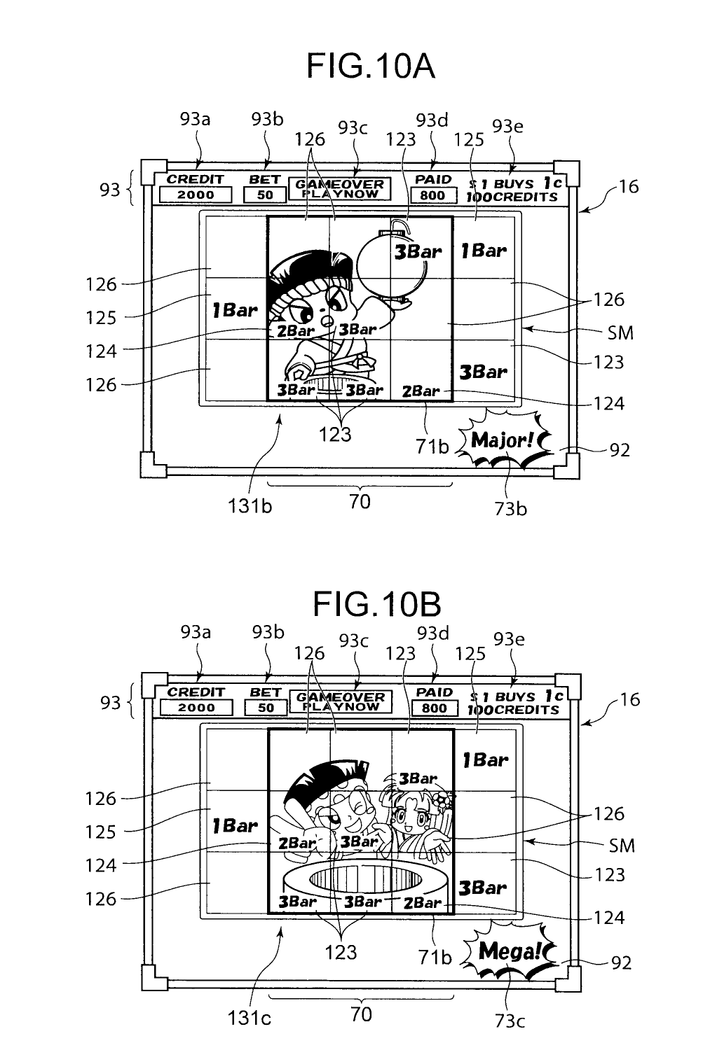

The plurality of pieces stored in a RAM 43 include a plurality of pieces (see FIG. 1A) making up a first picture intended to determine winning establishment of a free game as a special prize and a plurality of pieces (see FIG. 1B) making up a second picture intended to determine type of the free game. The second picture is made up of the plurality of pictures (FIGS. 9B, 10A, and 10B) corresponding to types of the free game (Mini, Major, and Mega).

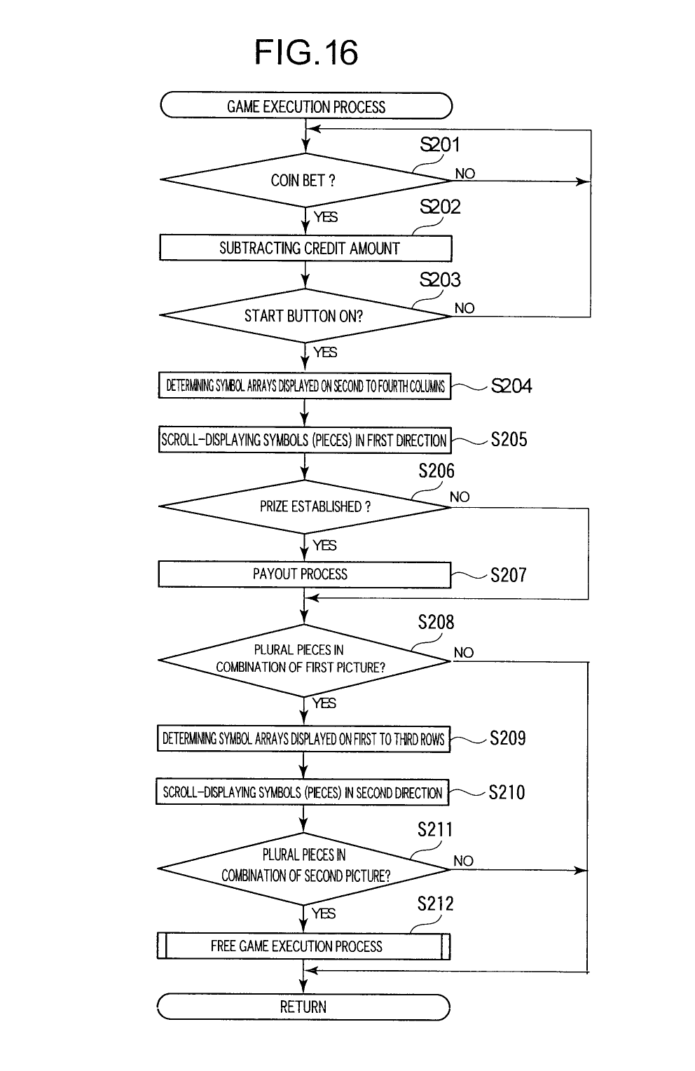

A main CPU 41 included in the slot machine 10 executes a process that follows (see FIG. 16), when accepting an input signal from a START button after coins are bet. First, the main CPU 41 randomly determines plural types of symbols to be rearranged on a display device.

The main CPU 41 then reads out of the RAM 43, the plurality of pieces making up the first picture. The main CPU 41 rearranges on the display device, plural types of symbols and a plurality of pieces making up the first picture drawn as a background of the symbols, so as to scroll-display the plural types of symbols in a first direction (a longitudinal direction) (S205).

The main CPU 41 awards a payout based upon rearranged symbols (S206) in a case where the symbols rearranged on the display device form a predetermined combination (three or more symbols of the same type). As shown in FIG. 1B, five symbols “3Bar” of the same type are arranged, and a predetermined payout is awarded based upon this arrangement.

The main CPU 41 then judges whether or not the plurality of pieces, which are drawn as a background of the symbols rearranged on the display device, are displayed in combination making up the first picture on the display device (S208). As a result, in a case of judgment that the plurality of pieces drawn as a background of the symbols make up the first picture (see FIG. 1A), the main CPU 41 determines to establish winning establishment of free game as a special prize.

The main CPU 41 reads a plurality of pieces making up a second picture out of the RAM 43. The main CPU 41 rearranges on the display device, plural types of symbols and the plurality of pieces making up the second picture drawn as a background of the symbols, so as to scroll-display the plural types of symbols in a second direction (a lateral direction) (S210).

In a case of judgment that the plurality of pieces, which are drawn as a background of the symbols, are displayed in combination making up the second picture on the display device (S211), the main CPU 41 determines type of free game (from among Mini, Major, and Mega) according to the second picture displayed on the display device. The main CPU 41 then executes the determined type of free game (S212).

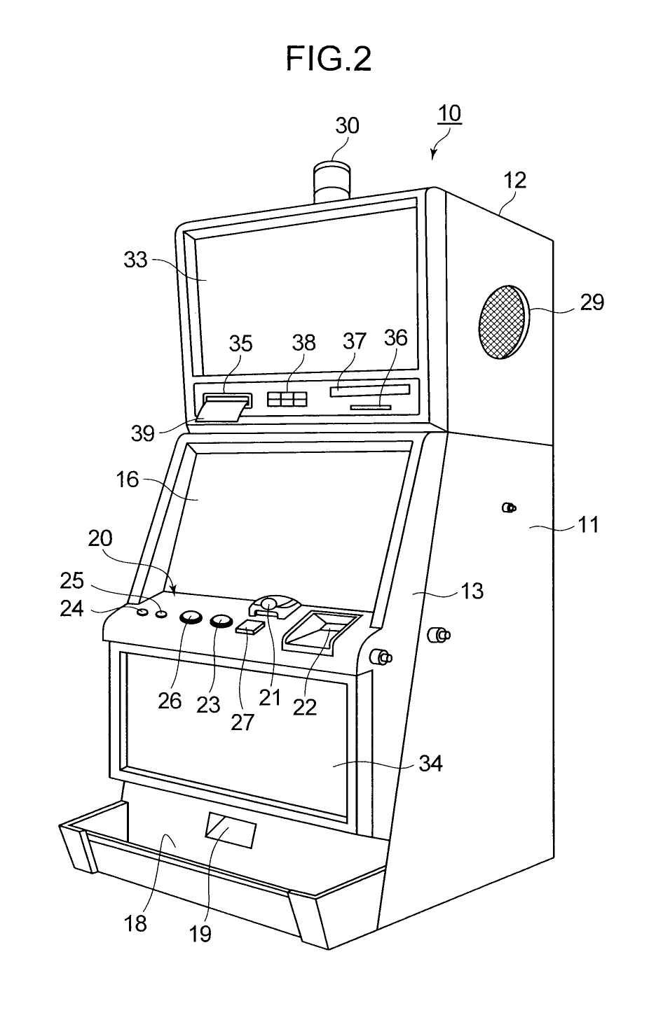

The slot machine 10 mentioned above will be explained in detail with reference to the drawings. FIG. 2 is a view schematically showing an appearance of the slot machine according to the first embodiment. While the slot machine 10 is of a stand-alone type, which is not connected to a network, the present invention is also applicable to a networked slot machine.

A basic game is executed upon consuming a gaming value corresponding to the amount bet by a player. A free game is executed without consuming a gaming value. A jackpot bonus game is to award a special payout.

The gaming media used in the slot machine 10 include coins, bills, or electronic value information equivalent thereto. In the present invention, however, medals, tokens, electronic money, or tickets, for example, may be employed as gaming media without being limitative thereto in particular. The above tickets are not limitative in particular, and can include barcode-attached tickets or the like, as described later, for example.

The slot machine 10 is provided with a cabinet 11, a top box 12 installed on an upper side of the cabinet 11, and a main door 13 provided on a front surface of the cabinet 11.

The lower image display panel 16 serving as a display device is provided in front of the main door 13. The lower image display panel 16 is provided with a liquid crystal panel, which displays a symbol matrix SM with fifteen elements in three rows and five columns. A single symbol is arranged in each of the elements of the symbol matrix SM.

An image display region 70 provided on a part of the symbol matrix SM displays the plurality of pieces making up a single picture. The plurality of pieces are drawn as a background of the plurality of symbols, thereby being displayed in association with display of the plural types of symbols in a stopped state.

Downwardly of the lower image display panel 16, a control panel 20 made up of a plurality of buttons 23 to 27 for entering instructions pertinent to the progress of a game by a player; a coin insertion slot 21 for accepting coins in the cabinet 11; and a bill validator 22 are provided.

On the control panel 20, a start button 23, a change button 24, a cashout button 25, a 1-BET button 26, and a max-BET button 27 are provided. The start button 23 is intended for entering a command for starting the game. The change button 24 is intended for use in asking an attendant of the gaming facility for change. The cashout button 25 is intended for entering a command for paying the credited coins to a coin tray 18 through a coin payout exit 19.

The 1-BET button 26 is intended for entering a command for betting one coin among the credited coins on the game. The max-BET button 27 is intended for entering a command for betting the upper number (fifty in this embodiment) of coins allowed to be bet per game from among the credited coins on the game.

The bill validator 22 validates whether or not a bill is legitimate and accepts a legitimate bill into the cabinet 11. The bill validator 22 may be configured so that a barcode-attached ticket 39 described later is readable thereby. Provided on a lower front surface of the main door 13, that is, at a lower part of the control panel 20, is a berry glass 34 on which characters of the slot machine 10 and the like are depicted.

On the front face of the top box 12, an upper image display panel 33 is provided. The upper image display panel 33 has a liquid crystal panel, which displays images for introducing the game contents or explaining game rules, for example. The panel also displays an image indicative of the remaining number of times in executing the free game when the free game is started.

Also, on the top box 12, a lamp 30 and a speaker 29 are provided. At the lower side of the upper image display panel 33, a ticket printer 35, a card reader 36, a data display 37, and a keypad 38 are provided. The ticket printer 35 prints, on tickets, bar codes containing coded data such as credit amount, date and time, or ID numbers of the slot machine 10, and the bar code-attached tickets 39 are output. A player causes another slot machine to read the bar-code-attached tickets 39, allowing the slot machine to perform games, or alternatively, allowing the exchange of bar-code-attached tickets 39 with bills or the like at a predetermined site of a game facility (for example, at the casher in a casino).

The card reader 36 reads data from and writes data into a smart card. The smart card is to be owned by the player, which stores data for identifying the player or data regarding the log of games executed by the player, for example. The smart card may store data equivalent to coins, bills, or credits. As an alternative of a smart card, a magnetic stripe card may be employed. The data display 37 is made up of a fluorescent display or the like, and stores data read by the card reader 36 or data input by a player via the keypad 38, for example. The keypad 38 is intended for entering the instructions or data pertinent to the issuance of tickets.

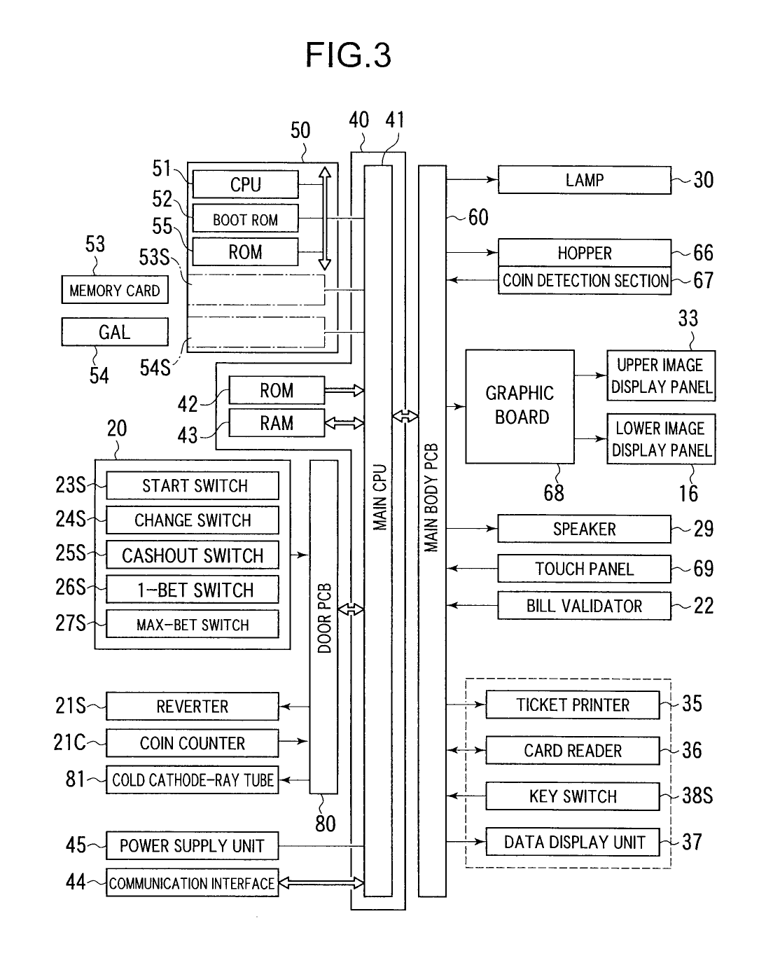

FIG. 3 is a block diagram showing an internal construction of the slot machine shown in FIG. 2. A gaming board 50 includes: a CPU (Central Processing Unit) 51, ROM (Read-only Memory) 55 and boot ROM 52 interconnected by an internal bus; a card slot 53S corresponding to a memory card 53; and an IC socket 54S corresponding to a GAL (Generic Array Logic) 54.

The memory card 53 is made up of non-volatile memories such as CompactFlash (registered trademark), and stores game programs. The game programs include a symbol selecting program and a piece selecting program. The symbol selecting program is intended to determine symbols to be rearranged in the symbol matrix SM. The piece selecting program is intended to determine a plurality of pieces to be rearranged in the image display region.

A payout ratio is determined based upon payout-ratio setting data output from the GAL 54. Further, the game programs include table data indicative of the correspondence relationship between each of the symbols and a payout.

In addition, a card slot 53S is constituted to enable removable insertion of the memory card 53, and is connected to a motherboard 40 by means of an IDE bus. Therefore, the memory card 53 is removed from the card slot 53S, other game programs and game system programs are written into the memory card 53, and thereafter, the memory card 53 is inserted into the card slot 53S, thereby making it possible to vary the kinds or contents of the games performed at the slot machine 10. The game programs include those which are relevant to the operating procedures for performing games. Furthermore, the game program includes image data or sound data to be output during the game. The image data include, for example, image data indicative of the symbol matrix SM.

The GAL 54 is type of PLD (Programmable Logic Device) having an OR-fixed arrayed structure. The GAL 54 is provided with a plurality of IN ports and OUT ports. If predetermined items of data are input to the IN port, the corresponding data is output from the OUT port. In addition, the IC socket 54S is constituted to enable removable insertion of the GAL 54, and is connected to a motherboard 40 by means of a PCI bus.

The CPU51, the ROM55, and the boot ROM52 interconnected via the internal bus are connected to the motherboard 40 via a PCI bus. The PCI bus not only performs signal transmission between the motherboard 40 and the gaming board 50, but also supplies power from the motherboard 40 to the gaming board 50.

The motherboard 40 is constructed using a general-purpose motherboard commercially available (a printed circuit board on which essential parts of a personal computer are mounted) and includes: a main CPU (Central Processing Unit) 41; a ROM (Read-only Memory) 42; a RAM (Random Access Memory) 43; and a communication interface 44. The main CPU 41 functions as a processor for controlling a display device and memory according to the embodiment of the present invention.

The ROM 42 is made up of a memory device such as flash memory, and stores a program such as a BIOS (Basic Input/Output System) executed by the main CPU41 and permanent data.

When the BIOS is executed by the main CPU 41, a process of initializing predetermined peripheral devices is carried out and a process of capturing game programs and game system programs stored in the memory card 53 through the gaming board 50 is started. In the embodiment of the present invention, the contents of the ROM 42 may be rewritable or not.

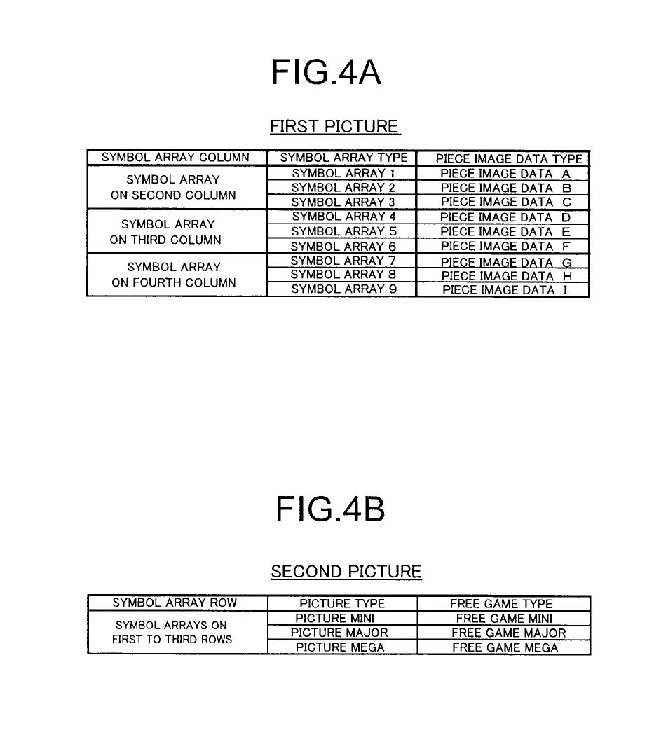

The RAM 43 stores data and programs used when the main CPU 41 is activated. The RAM 43 can also store game programs. Further, the RAM 43 stores data relating to the credit amount and the number of inserted coins or the number of paid-out coins in one game. The RAM 43 stores the plurality of pieces making up the first picture intended to determine winning establishment of a free game as a special prize, and the plurality of pieces making up the second picture intended to determine type of free game. The RAM 43 stores these plural pieces in the form of various data tables shown in FIGS. 4A and 4B.

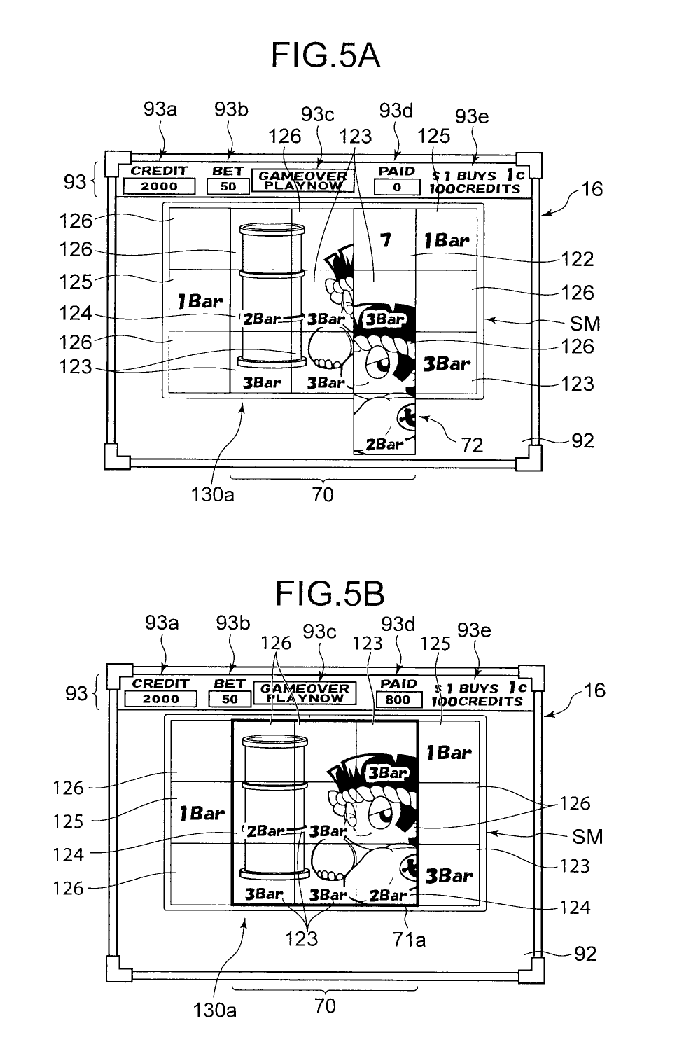

FIG. 4A is a view showing an image data table of pieces making up the first picture. The piece image data table shown in FIG. 4A includes image data A to I concerning the plurality of pieces corresponding to symbol arrays on the second to fourth columns making up the first picture intended to determine establish of winning a free game. The piece image data A to C correspond to symbol arrays 1 to 3 of the second column making up part of the first picture to be described later. The images corresponding to the data A to C are displayed in the image display region 70 in FIG. 5B in a case where any of the symbol arrays 1 to 3 of the second column is determined at random. The piece image data D to F correspond to symbol arrays 4 to 6 of the third column making up part of the first picture to be described later. The images corresponding to the data D to F are displayed in the image display region 70 in FIG. 5B in a case where any of the symbol arrays 4 to 6 of the third column is determined at random. The piece image data G to I correspond to symbol arrays 7 to 9 of the fourth column making up part of the first picture to be described later. The images corresponding to the data G to I are displayed in the image display region 70 in FIG. 5B in a case where any of the symbol arrays 7 to 9 of the fourth column is determined at random.

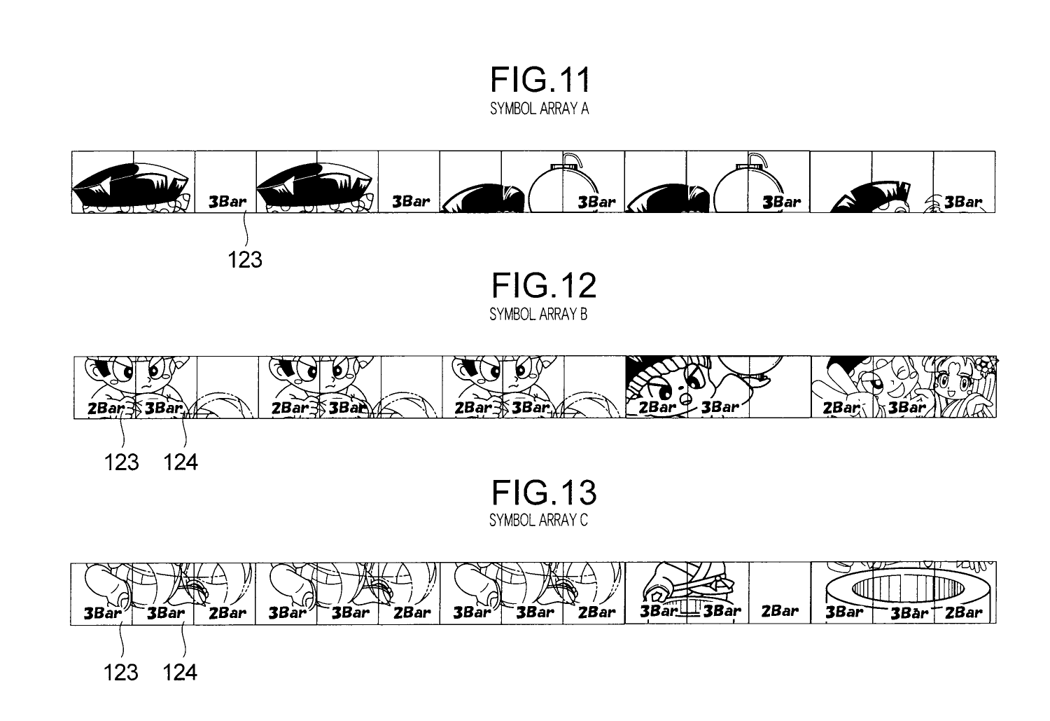

FIG. 4B is a view showing types of the second picture and types of the free game. The second picture includes three types of pictures, “Mini”, “Major”, and “Mega” corresponding to types of the free game. When the picture of “Mini” is established in combination of the symbol arrays A to C on the first to third rows shown in FIG. 11 to be described later, the free game of “Mini” is determined as a prize. When the picture of “Major” is established in combination of the symbol arrays A to C on the first to third rows shown in FIG. 11 to be described later, the free game of “Major” is determined as a prize. When the picture of “Mega” is established in combination of the symbol arrays A to C on the first to the third rows shown in FIG. 11 to be described later, the free game of “Mega” is determined as a prize.

Referring back to FIG. 3, both a main body PCB (Printed Circuit Board) 60 and a door PCB80, which will be described later, are connected to the motherboard 40 by the USB. A power supply unit 45 is also connected to the motherboard 40.

To the main body PCB 60 and the door PCB 80, equipment or devices for generating an input signal input to the main CPU 41, and those of which operation is controlled by means of a control signal output from the main CPU 41, are connected. The main CPU 41 executes the game programs stored in RAM 43, based upon an input signal that was input to the main CPU 41, thereby performing a predetermined computational process. Then, this CPU 41 stores results thereof into RAM 43; and transmits control signals to equipment and devices as a control process relative to the equipment and devices.

Connected to the main body PCB 60 are a lamp 30, a hopper 66, a coin detection section 67, a graphic board 68, a speaker 29, a touch panel 69, a bill validator 22, a ticket printer 35, a card reader 36, a key switch 38S, and a data display 37. The lamp 30 lights in a predetermined pattern, based upon a control signal output from the main CPU 41.

The hopper 66 is installed in a cabinet 11, and the predetermined amount of coins are paid out from the coin payout opening 19 to the coin tray 18, based upon the control signal output from the main CPU 41. A coin detection section 67 is provided inside of the coin payout opening 19, and outputs an input signal to the main CPU 41, if it is detected that the predetermined amount of coins have been paid out from the coin payout opening 19.

A graphic board 68 controls the images to be displayed on the upper and lower image display panels 33 and 16, based upon the control signal output from the main CPU 41. The credit amount display section 93a (see FIG. 4) on the lower image display panel 16 displays the amount of credits stored in the RAM 43. Further, the PAID amount display section 93d (see FIG. 4) on the lower image display panel 16 displays the amount of coins to be paid out.

The graphic board 68 is provided with: a VDP (Video Display Processor), which generates image data, based upon the control signal output from the main CPU 41; and video RAM, etc., which temporarily stores image data generated by video image ROM, video image RAM, and the VDP. The graphic board 68 reads the image data out of the video image ROM based upon the determined contents, thereby forming and outputting the image based upon the read-out data, to the lower image display panel 16. The upper image display panel 33 and the lower image display panel 16 display the input video images.

The video image RAM temporarily stores the data used when the VDP is operated. The video image ROM stores the data concerning the plurality of pieces making up the first and second pictures. The video image ROM stores the symbol image data concerning symbols to be displayed in the symbol matrix display region SM. The video image RAM stores a memory region storing the symbol image data and a memory region storing the piece data.

The VDP forms video images by superimposing data read from each of the memory regions, and then, outputs the resultant images to each of the display panels 16, 33. The plurality of pieces are thus displayed on the image display region 70 as if they are drawn as the background of the plural types of symbols. The image data used when the image data is generated by the VDP is read out of the memory card 53, and thereafter, is included in the game programs stored in the RAM 43.

The speaker 29 outputs sound such as BGM in accordance with sound data output from the main CPU 41. The touch panel 69 is disposed on a front surface of the lower image display panel 16, which enables players to operate the touch panel 69 to input various instructions.

The bill validator 22 validates whether or not a bill is legitimate and accepts a legitimate bill into the cabinet 11. The bill validator 22, upon accepting a legitimate bill, outputs an input signal to the main CPU 41 based upon the bill amount. The main CPU 41 stores in the RAM 43 the amount of credits responsive to the amount of bills transmitted by the input signal.

Based upon a control signal output from the main CPU 41, the ticket printer 35 prints on a ticket a barcode having encoded thereon data such as the credit amount, data and time, and the identification number of the slot machine 10 stored in the RAM 43. Further, this printer outputs the printed ticket as a barcode-attached ticket 39. The card reader 36 reads data from a smart card, thereby transmitting the read data to the main CPU 41 or writing data into the smart card, based upon the control signal from the main CPU 41. The key switch 38S is provided on the key pad 38, and outputs a predetermined input signal to the main CPU 41 when a player operates the key pad 38. The data display 37 displays, based upon a control signal output from the main CPU 41, the data read by the card reader 36 and the data input by a player through the key pad 38.

To the door PCB 80, a control panel 20, a reverter 21S, a coin counter 21C, and a cold cathode-ray tube 81 are connected. The control panel 20 is provided with: a start switch 23S corresponding to the start button 23; a change switch 24S corresponding to the change button 24; a cashout switch 25S corresponding to a cashout button 25; a 1-BET switch 26S corresponding to a 1-BET button 26; and a max-BET switch 27S corresponding to the max-BET button 27. When the player operates the buttons 23 to 27, the corresponding switches 23S to 27S output input signals to the main CPU 41, respectively.

The coin counter 21C is provided inside the coin receiving slot 21, and validates whether or not a legitimate coin is inserted into the coin receiving slot 21. Those other than the legitimate coins are discharged from the coin payout exit 19. The coin counter 21C outputs an input signal to the main CPU 41 when a legitimate coin is detected.

The reverter 21S is operable based upon the control signal output from the main CPU 41. This reverter distributes the coins recognized to be legitimate by the coin counter 21C, into a cashbox (not shown) or a hopper 66 which was installed in the slot machine 10. In other words, if the hopper 66 is filled with coins, the legitimate coins are distributed to the cashbox by means of the reverter 21 S. Otherwise, the legitimate coins are distributed to the hopper 66. The cold cathode-ray tube 81 functions as a backlight installed at the rear side of the lower and upper image display panels 16, 33, and lights based upon the control signal that was output from the main CPU 41.

FIGS. 5A to 9B are views each showing an exemplary image displayed in the slot machine shown in FIG. 2 according to the first embodiment. FIGS. 5A and 5B are views each showing an exemplary symbol matrix SM displayed during the basic game.

As shown in FIG. 5A, the lower image display panel 16 is made up of a display region 92, an information display section 93, and the like. The display region 92 is for displaying a symbol matrix SM.

The information display section 93 is arranged upwardly of the display region 92 and is made up of a credit amount display section 93a, a BET amount display section 93b, a character information display section 93c, a PAID amount display section 93d, and a charge display section 93e.

The amount of coins presently credited is displayed at the credit amount display section 93a while the amount of coins bet in one game is displayed at the BET amount display section 93b. The character information indicative of a current status of the game is displayed at the character information display section 93c. The characters of “PLAYNOW” are displayed during the play of the game, whereas the characters of “GAMEOVER” are displayed during the intervals between the plays of the game. The amount of coins that have been successfully obtained in one game is displayed at the PAID amount display section 93d, whereas a conversion value of the credit amount based upon a predetermined charge is displayed at the charge display section 93e.

A total of fifteen symbols in five columns and three rows are rearranged on the symbol matrix SM displayed on the lower image display panel 16. The symbol matrix SM displays symbols “WILD” 121, “7” 122, “3Bar” 123, “2Bar” 124, “1Bar” 125, and “Blank”” 126.

The symbol columns on the symbol matrix SM include the first to fifth columns, in which the image display region 70 is formed in the second to fourth columns. The image display region 70 performs a composite image of the plural types of symbols and the plural pieces making up the single picture. This composite image of the symbols and the pieces is displayed so as to draw the pieces as the background of the symbols.

FIGS. 5A and 5B are views each showing an exemplary display screen displayed during the basic game. As shown in FIG. 5A, the plurality of pieces making up the first picture intended to determine winning establishment of the free game as a special prize are drawn as the background of the plural types of symbols. The plural types of symbols, in which the plurality of symbols making up the first picture are drawn as the background of the symbols, are rearranged in a scroll-display manner in the first direction (the longitudinal direction).

As shown in FIG. 5B, as a result of rearrangement of the plural types of symbols, the plurality of pieces drawn as the background of the symbols are combined with one another to be displayed in combination making up the single first picture. In a case where the first picture is displayed, winning establishment of the free game as the special prize is determined. As shown, a frame 71a is displayed to notify a player that the first picture has been made up. Furthermore, as a result of rearrangement of the plural types of symbols, three or more symbols “3Bar” of the same type are displayed, so that a payout is awarded based upon the number of the same symbols.

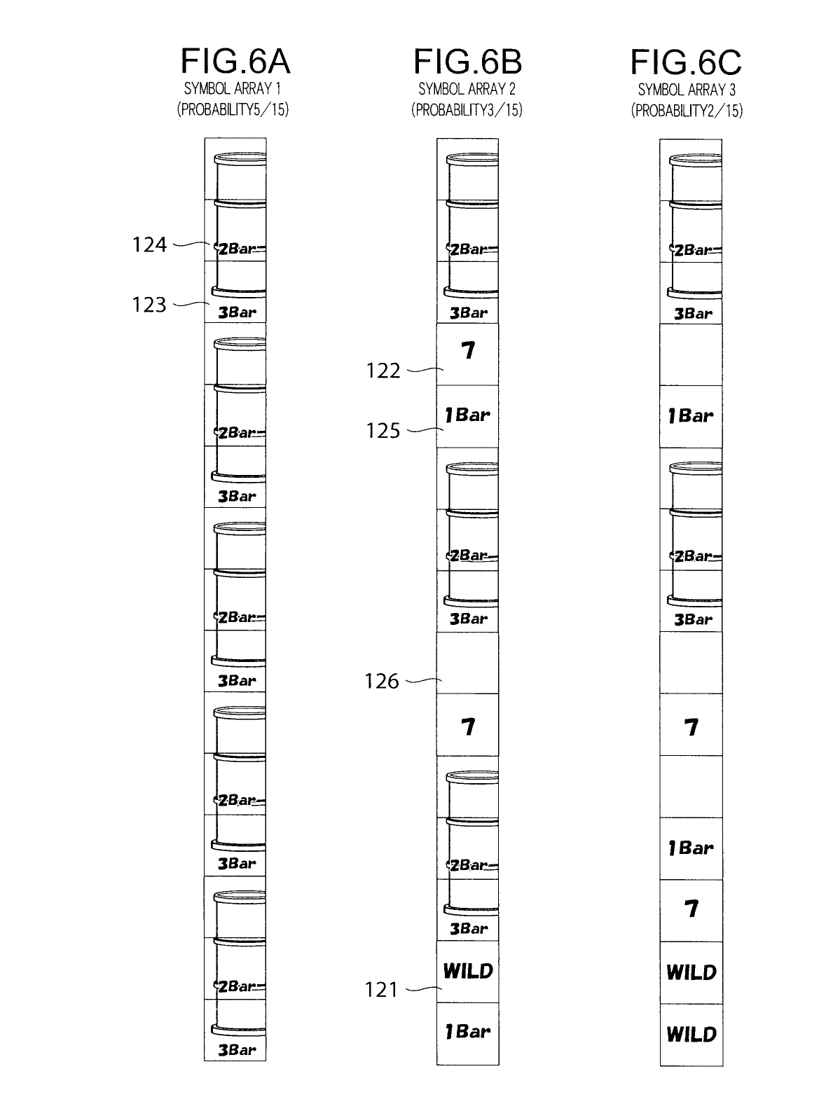

FIGS. 6A to 8C are views each showing a symbol array including the plurality of symbols making up the first picture.

FIGS. 6A to 6C are views each showing a symbol array on the second column making up the first picture. A symbol array on the second column is determined at random from among the symbol arrays 1 to 3 shown in FIGS. 6A to 6C.

As shown in FIG. 6A, fifteen stopping patterns include five stopping patterns in which the pieces stop at a center of the second column to make up the single picture. This means that 5/15 is the probability that scrolling of the array is stopped such that the plurality of pieces make up the single first picture.

As shown in FIG. 6B, fifteen stopping patterns include three stopping patterns in which the pieces stop at the center of the second column to make up the single picture. This means that 3/15 is the probability that scrolling of the array is stopped such that the plurality of pieces make up the single first picture.

As shown in FIG. 6C, fifteen stopping patterns include two stopping patterns in which the pieces stop at the center of the second column to make up the single picture. This means that 2/15 is the probability that scrolling of the array is stopped such that the plurality of pieces make up the first picture.

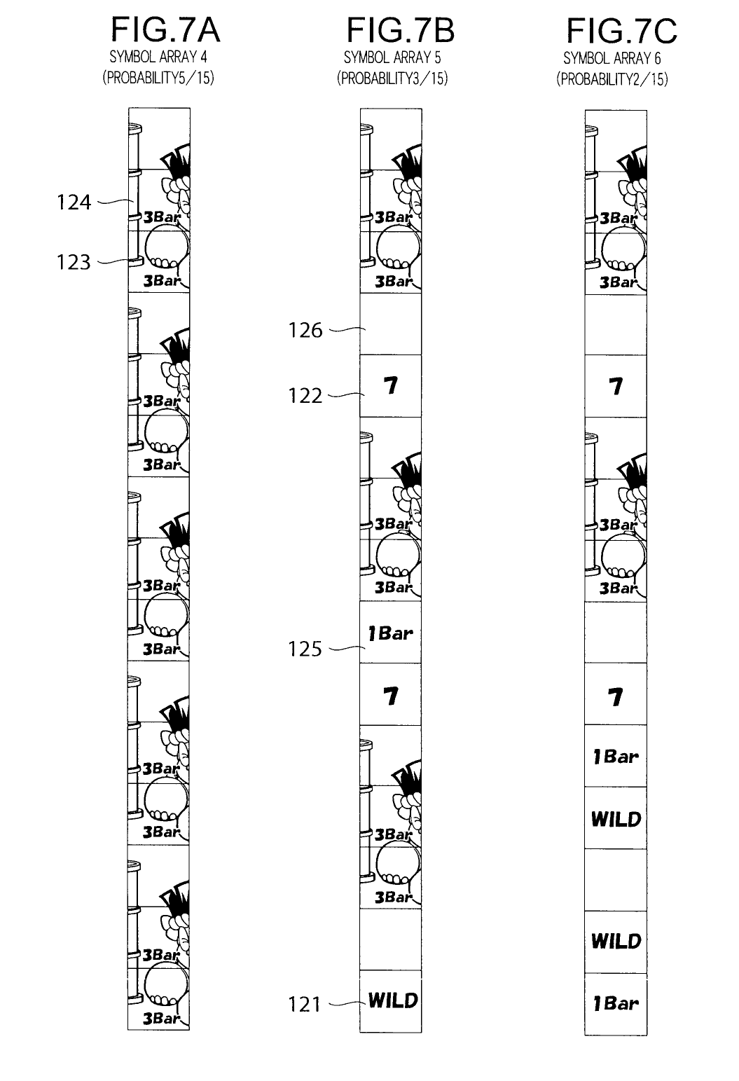

FIGS. 7A to 7C are views each showing a symbol array on the third column making up the first picture. A symbol array on the third column is determined at random from among the symbol arrays 4 to 6 shown in FIGS. 7A to 7C.

As shown in FIG. 7A, fifteen stopping patterns include five stopping patterns in which the pieces stop at a center of the third column to make up the single picture. This means that 5/15 is the probability that scrolling of the array is stopped such that the plurality of pieces make up the single first picture.

As shown in FIG. 7B, fifteen stopping patterns include three stopping patterns in which the pieces stop at the center of the third column to make up the single picture. This means that 3/15 is the probability that scrolling of the array is stopped such that the plurality of pieces make up the single first picture.

As shown in FIG. 7C, fifteen stopping patterns include two stopping patterns in which the pieces stop at the center of the third column to make up the single picture. This means that 2/15 is the probability that scrolling of the array is stopped such that the plurality of pieces make up the single first picture.

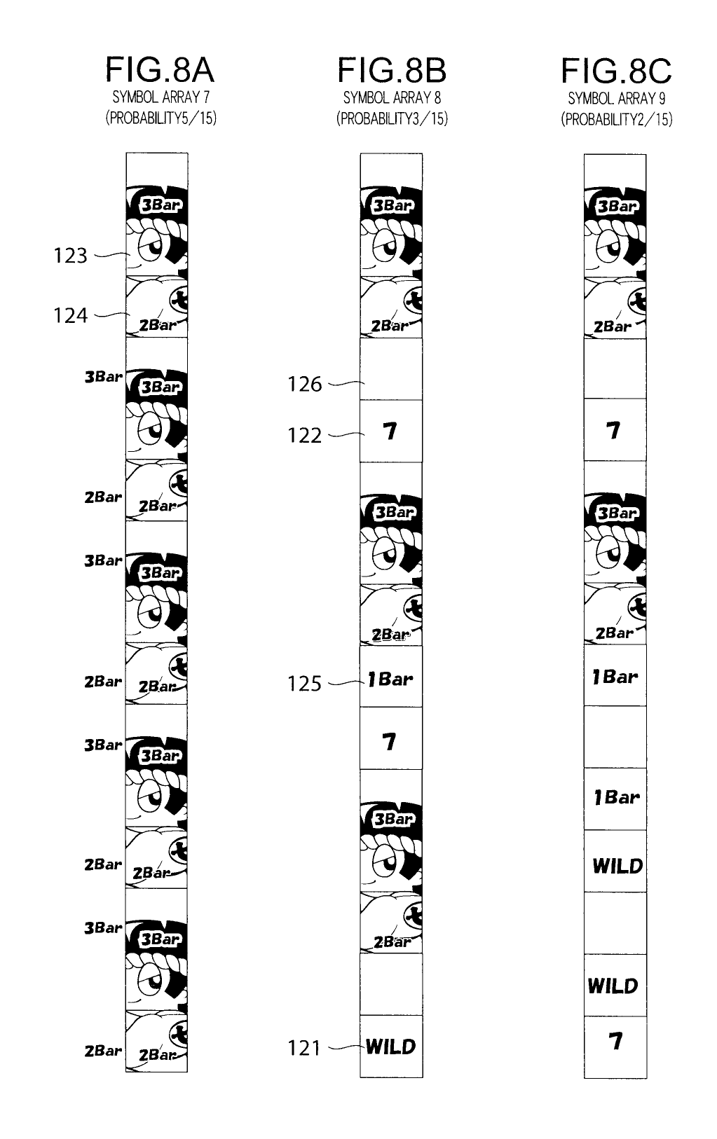

FIGS. 8A to 8C are views each showing a symbol array on the fourth column making up the first picture. A symbol array on the fourth column is determined at random from among the symbol arrays 7 to 9 shown in FIGS. 8A to 8C.

As shown in FIG. 8A, fifteen stopping patterns include five stopping patterns in which the pieces stop at a center of the fourth column to make up the single picture. This means that 5/15 is the probability that scrolling of the array is stopped such that the plurality of pieces make up the single first picture.

As shown in FIG. 8B, fifteen stopping patterns include three stopping patterns in which the pieces stop at the center of the fourth column to make up the single picture. This means that 3/15 is the probability that scrolling of the array is stopped such that the plurality of pieces make up the single first picture.

As shown in FIG. 8C, fifteen stopping patterns include two stopping patterns in which the pieces stop at the center of the fourth column to make up the single picture. This means that 2/15 is the probability that scrolling of the array is stopped such that the plurality of pieces make up the first picture.

For example, the assumption is made that the symbol array 1 shown in FIG. 6A is set to the array on the second column; the symbol array 5 shown in FIG. 7B is set to the array on the third column; and the symbol array 9 shown in FIG. 8C is set to the array on the fourth column. In this assumption, the probability that the plurality of pieces are displayed to make up the single first picture is set to equal to 2/225 determined by a formula, (5/15)×(3/15)×(2/15). That is, the probability changes depending on arrays selected as the second to fourth symbol arrays.

FIGS. 9A, 9B, 10A, and 10B are views each showing an exemplary display screen displayed during the basic game. As shown in FIG. 9A, the plurality of pieces, which make up the second picture intended to determine type of the free game (from among Mini, Major, and Mega), are drawn as the background of the plural types of symbols. The plural types of symbols, in which the plurality of pieces making up the second picture are drawn as the background of the symbols, are rearranged in a scroll-display manner in the second direction (the lateral direction). The second picture is made up of the plurality of pictures (FIGS. 9B, 10A, and 10B) that are different depending on type of the free game (Mini, Major, or Mega).

As shown in FIG. 9B, as a result of rearrangement of the plural types of symbols, the plurality of pieces drawn as the background of the symbols are combined with one another to be displayed in combination making up the single second picture shown in FIG. 9B. In a case where the second picture shown in FIG. 9B is displayed, type of the free game is determined as “Mini”.

As shown in FIG. 10A, as a result of rearrangement of the plural types of symbols, the plurality of pieces drawn as the background of the symbols are combined with one another to be displayed in combination making up the second picture shown in FIG. 10A. In a case where the second picture shown in FIG. 10A is displayed, type of the free game is determined as “Major”.

As shown in FIG. 10B, as a result of rearrangement of the plural types of symbols, the plurality of pieces drawn as the background of the symbols are combined with each other to be displayed in combination making up the single second picture shown in FIG. 10B. In a case where the second picture shown in FIG. 10B is displayed, type of the free game is determined as “Mega”.

FIGS. 11 to 13 are views showing the plurality of symbols making up the second picture. FIG. 11 is a view showing an array of plural symbols on the first column making up the second picture. FIG. 12 is a view showing an array of plural symbols on the second column making up the second picture. FIG. 13 is a view showing an array of plural symbols on the third column making up the second picture.

The symbol array of plural symbols on the first column (FIG. 11) is made up of two patterns making up a combination for the free game “Mini”; two patterns making up a combination for the free game “Major”; and one pattern making up a combination for the free game “Mega”.

The symbol array of plural symbols on the second column (FIG. 12) is made up of three patterns making up a combination for the free game “Mini”; one pattern making up a combination for the free game “Major”; and one pattern making up a combination for the free game “Mega”.

The symbol array of plural symbols on the third column (FIG. 13) is made up of three patterns making up a combination for the free game “Mini”; one pattern making up a combination for the free game “Major”; and one pattern making up a combination for the free game “Mega”.

With respect to the probability of winning the free game according to a combination of the arranged symbols described above, the winning probability is determined such that free game types “Mini”, “Major”, and “Mega” are won in order of the highest to lowest winning probabilities.

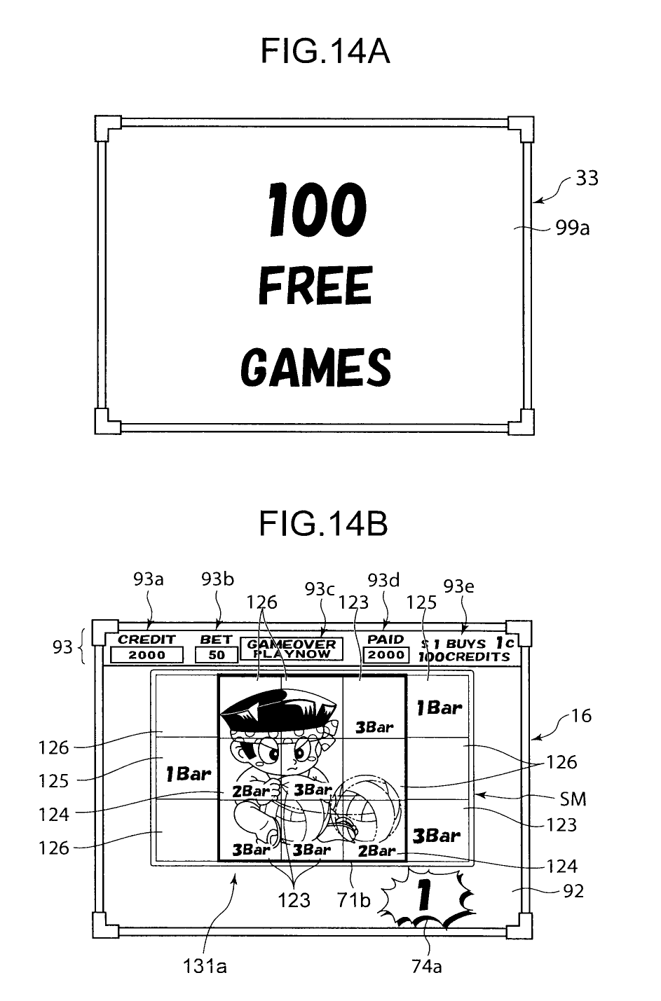

FIGS. 14A and 14B are views each showing an exemplary display screen displayed during the free game. As shown in FIG. 14A, upon start of the free game, the upper image display panel 33 displays the free-game-number display image indicative of the remaining number of times in executing the free game. Upon start of the free game, a free-game-number display image 99a such as “100 FREE GAMES” is displayed which indicates that 100 free games remain, for example.

As shown in FIG. 14B, in a case where the plurality of partial pieces are combined to display the single second picture, a counted-number display image 74a is displayed, which represents the accumulatively-counted number of times in displaying the second picture.

Next, a process executed in the slot machine 10 according to this embodiment, will be described in detail with reference to the drawings. The main CPU 41 reads and executes a game program, thereby conducting the game.

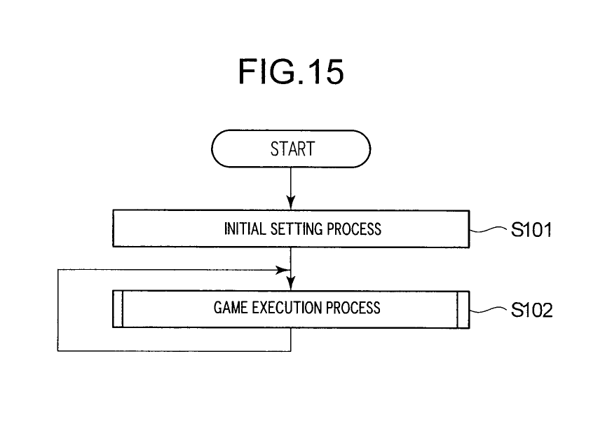

FIG. 15 is a flowchart showing a subroutine of the main process. In the main process, first, when a power switch is turned on (that is, when power is supplied), a motherboard 40 and a gaming board 50 are activated respectively, so that the CPU 41 executes an initial setting process (step S101). In this initial setting process, the main CPU 41 executes the BIOS stored in the ROM 42, decompresses, in the RAM 43, compressed data included in the BIOS, executes the BIOS decompressed in the RAM 43, and performs diagnosis and initialization of each of the peripheral devices. The main CPU 41 also performs an authentication process for each program during execution of the initial setting process.

Next, the main CPU 41 carries out a game execution process to be described later (step S102). In this game execution process, the main CPU 41 sequentially reads and executes the game programs or the like from the ROM42. By performing this game execution process, the slot machine 10 executes the game according to this embodiment. The game execution process is repeatedly performed while power is supplied to the slot machine 10.

FIG. 16 is a flowchart showing a subroutine of the game execution process. This game execution process is carried out at step S102 in FIG. 15.

The main CPU 41 judges at step S201 whether or not a coin has been bet. Specifically, the main CPU 41 judges whether or not an input signal has been received, the signal being output from the 1-BET switch 26S when the 1-BET button 26 is pushed, or alternatively, being output from the max-BET switch 27S when the MAX-BET button 27 is pushed. In a case where the main CPU 41 judges that the coin has been bet (S201: YES), the routine proceeds to step S202. In a case where the main CPU 41 judges that the coin has not been bet (S201: NO), the routine returns to step S201.

Next, at step S202, the main CPU 41 subtracts the amount of bet coins from the credit amount stored in the RAM 43 upon judging at step S201 that the coin has been bet. In a case where the amount of bet coins is greater than the credit amount stored in the RAM 43, the routine returns to step S201 without execution of the process of subtracting the number of bet coins from the credit amount stored in the RAM 43. In a case where the amount of bet coins exceeds the upper limit (fifty coins in this embodiment) of coins that can be bet in one game, the routine proceeds to step S203 without execution of the process of subtracting the amount coins from the credit amount stored in the RAM 43.

Next, at step S203, the main CPU 41 judges whether or not the start button 23 has been set to ON. Specifically, the main CPU 41 judges whether or not an input signal has been received, the signal being output from the start switch 23S when the start button 23 is pushed. In a case where the main CPU 41 judges that the start button 23 has not been set to ON (step S203: NO), the routine returns to step S201. Where the start button 23 has not been set to ON (for example, where an instruction has been input to terminate the game without setting the start button 23 to ON), the main CPU 41 cancels acceptance of a subtraction result at step S202. On the other hand, in a case where the main CPU 41 judges that the start button 23 has been set to ON (S203: YES), the routine proceeds to step S204.

Next, at step S204, the main CPU 41 determines the symbol arrays to be used on the second to fourth columns making up the first picture intended for winning establishment of the special prize, upon judging at step S203 that the start button 23 has been set to ON (S203: YES). Specifically, the main CPU 41 executes the program stored in the RAM 43 to sample random numeric values in a numerical range which comes under a predetermined range of random numeric values. The main CPU 41 then compares the sampled random numeric values with a range of random numeric values corresponding to the symbol arrays, thereby determining the symbol arrays at random. Herein, any one of the symbol arrays shown in FIGS. 6A to 6C is determined at random as the one used on the second column. Any one of the symbol arrays shown in FIGS. 7A to 7C is determined at random as the one used on the third column. Any one of the symbol arrays shown in FIGS. 8A to 8C is determined at random as the one used on the fourth column.

Next, at step S205, the main CPU 41 scroll-displays the plural types of symbols (the plurality of pieces) in the first direction (the longitudinal direction). Specifically, the main CPU 41 scroll-displays in the first direction (the longitudinal direction), the plural types of symbols having as the background, the plurality of pieces making up the single first picture intended for determining winning establishment of the special prize. The main CPU 41 executes a program in which the RAM 43 stores symbols arranged in the symbol matrix SM to be displayed on the lower image display panel 16. The main CPU 41 then samples random numeric numbers in a predetermined numerical range. The main CPU 41 then compares the sampled random numeric values with a range of random numeric values respectively corresponding to the symbol arrays, thereby determining each of the symbols rearranged in the symbol matrix SM.

Next, at step S206, the main CPU 41 judges whether or not a prize has been established. Specifically, the main CPU 41 judges whether or not a predetermined number or more of (for example, three or more) of symbols of the same type are rearranged in the symbol matrix SM. In a case where the main CPU 41 judges that the prize has been established (S206: YES), the routine proceeds to step S207. On the other hand, where the main CPU 41 judges that the prize has not been established (S206: NO), the routine proceeds to step S208.

Next, at step S207, upon judging that the prize has been established (step S206: YES), the main CPU 41 performs a coin-payout process in accordance with the bet amount and the amount of coins set for the number of symbols of the same type. In this case, where the coins are deposited, the main CPU 41 executes a process of adding the amount of coins to be paid out to the credit amount stored in the RAM 43. On the other hand, in a case of payout of the coins, the main CPU 41 pays out the predetermined amount of coins by transmitting a control signal to the hopper 66.

Next, at step S208, upon judging that the prize has not been established (S206: NO) or executing the payout process at step S207, the main CPU 41 judges whether or not the plurality of pieces drawn as the background of the plural types of symbols are combined with one another in the symbol matrix SM to be displayed in combination making up the single first picture intended to determine winning establishment of the special prize. For example, as shown in FIG. 5B, the main CPU 41 judges whether or not the plurality of pieces are displayed in combination making up the single first picture in the symbol matrix SM. Upon judging that the plurality of pieces are displayed in combination making up the single first picture (S208: YES), the main CPU 41 determines winning establishment of the free game as the special prize and the routine proceeds to step S209. Upon judging that the plurality of pieces are not displayed in combination making up the single first picture (S208: NO), the main CPU 41 terminates the game execution process. Incidentally, upon judging that the plurality of pieces are displayed in combination making up the single first picture (step S208: YES), the main CPU 41 displays a frame 71a to notify a player that winning establishment of the free game as the special prize has been determined, as shown in FIG. 5B.

Next, at step S209, the main CPU 41 determines symbol arrays to be used on the first to third rows making up the second picture intended for determining type of a special prize. Specifically, the main CPU 41 executes the program stored in the RAM 43 to sample random numeric values in a numerical range which comes under a predetermined range of random numeric values. The main CPU 41 then compares the sampled random numeric values with a range of random numeric values corresponding to the symbol arrays, thereby determining the symbol arrays at random. Herein, any one of the symbol arrays shown in FIG. 11 is determined at random as the one used on the first row. Any one of the symbol arrays shown in FIG. 12 is determined at ransom as the one used on the second row. Any one of the symbol arrays shown in FIG. 13 is determined at random as the one used on the third array.

Next, at step S210, the main CPU 41 scroll-displays the plural types of symbols (the plurality of pieces) in the second direction (the lateral direction). Specifically, the main CPU 41 scroll-displays the plural types of symbols having as the background, the plurality of pieces making up the second picture. Specifically, the main CPU 41 executes a program stored in the RAM 43. The main CPU 41 then samples random numeric values in a numerical range which comes under a predetermined range of random numeric values. The main CPU 41 thus compares the sampled random numeric values with a range of random numeric values corresponding to the symbols, respectively, thereby determining at random the symbols to be rearranged in the symbol matrix SM.

Next, at step S211, the main CPU 41 judges whether or not the plurality of pieces, which are drawn as a background of the plural types of symbols, are displayed in combination making up the second picture. For example, as show in FIGS. 9B, 10A, and 10B, the main CPU 41 judges whether or the plurality of pieces are combined with one another on the symbol matrix SM to make up the second picture. Upon judging that the plurality of the pieces are displayed in combination making up the single second picture (S211: YES), the main CPU 41 determines type of the free game as the special prize and the routine proceeds to step S212. Upon judging that the plurality of pieces are not displayed in combination making up the single second picture (S211: NO), the main CPU 41 terminates the game execution process. Incidentally, upon judging that the plurality of pieces are displayed in combination making up the single second picture (Step S11: YES), the main CPU 41 displays a frame 71b to notify a player that type of the free game as the special prize has been determined.

Next, at step S211, the main CPU 41 performs a game execution process of the free game as the special prize. Herein, the main CPU 41 reads executes game programs or the like out of the ROM 42, thereby performing the free game process.

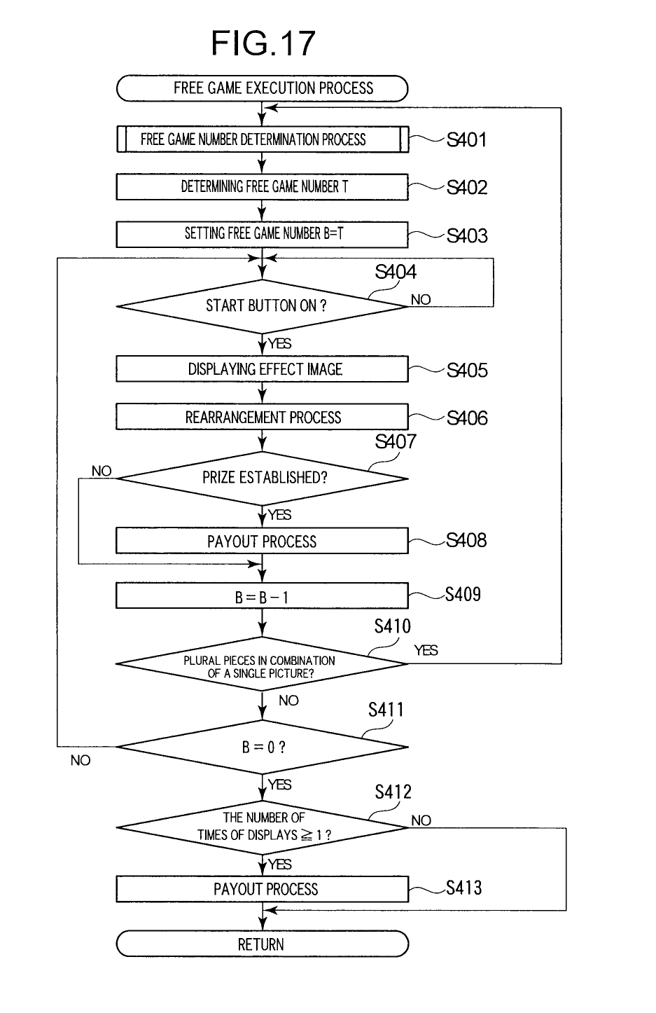

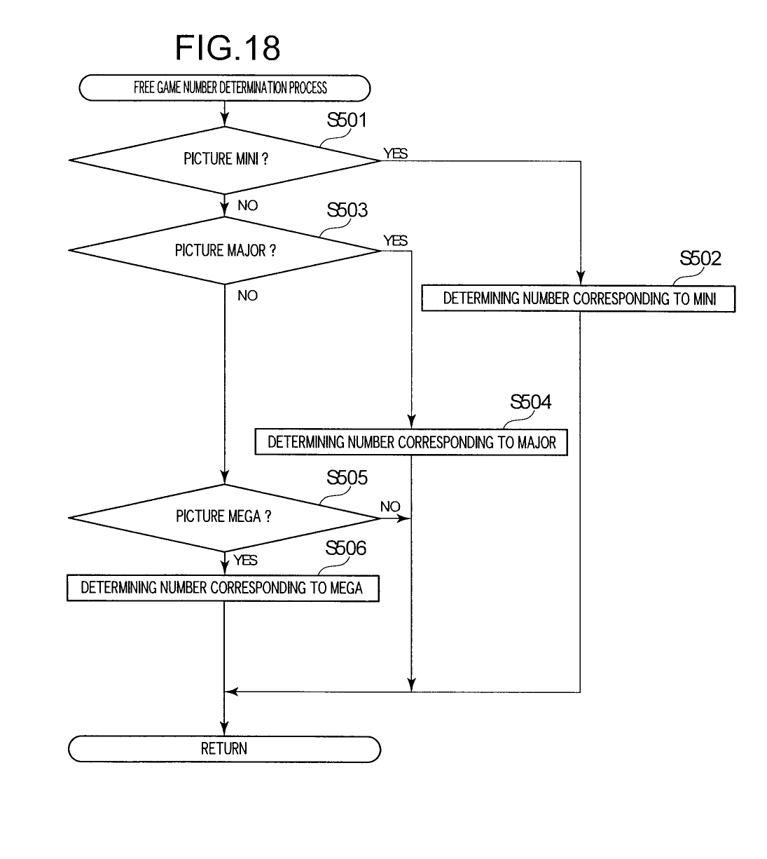

FIG. 17 is a flowchart showing a subroutine of a free game execution process. FIG. 18 is a flowchart showing a subroutine of a process of determining the number of times in executing the free game.

Next, at step S401, the main CPU 41 performs a process of determining the number of times in executing the free game, i.e., the free game number. First, the free game number determination process will be described with reference to FIG. 18.

As shown in FIG. 18, the main CPU 41 judges at step S501 whether or not the second picture displayed at step S211 is a picture of “Mini” indicative of type of the free game shown in FIG. 9B. Upon judging that the second picture is type of “Mini” (S501: YES), the main CPU 41 determines the free game number corresponding to the “Mini” picture (step S502). Upon execution of a process at step S502, the main CPU 41 then terminates the process of determining the free game number and the routine proceeds to step S402 shown in FIG. 17. On the other hand, upon judging that the second picture is not type of “Mini” (S501: NO), the routine CPU 41 proceeds to step S503.

Next, at step S503, the main CPU 41 judges whether or not the second picture displayed at step S211 is a picture of “Major” indicative of type of the free game shown in FIG. 10A. Upon judging that the second picture is type of “Major” (S503: YES), the main CPU 41 determines the free game number corresponding to the “Major” picture (step S504). Upon execution of a process at step S504, the main CPU 41 then terminates the process of determining the free game number and the routine proceeds to step S402 shown in FIG. 17. On the other hand, upon judging that the second picture is not type of “Major” picture (S503: NO), the routine CPU 41 proceeds to step S505.

Next, at step S505, the main CPU 41 judges whether or not the second picture displayed at step S211 is a picture of “Mega” indicative of type of the free game, shown in FIG. 10B. Upon judging that the second picture is type of “Mega” (S505: YES), the main CPU 41 determines the number of times in executing the free game, corresponding to the “Mega” picture (step S506). Upon execution of a process at step S506 or judging that the second picture is not type of “Mega” (S505: NO), the main CPU 41 then terminates the process of determining the free game number and the routine proceeds to step S402 shown in FIG. 17.

Next, at step S402, the main CPU 41 determines the number of times in executing the free game, i.e., the free game number T. Specifically, the main CPU 41 executes the program stored in the RAM 43, thereby reading the free game number that is set in association with a random number using a random numeric value sampled in a numerical range which comes under a predetermined range of random numeric values 1 to 256. After that, the main CPU 41 determines the free game number T.

Next, the main CPU 41 sets the free game number B to T (step S403). Specifically, the main CPU 41 sets a remaining free game number B to be equal to T in the memory region provided in the RAM 43, the area being intended for storing the data indicative of the remaining free game number B. A value of T is equal to the free game number T determined at step S402.

Next, at step S404, the main CPU 41 then judges whether or not the start button 23 has been set to ON. Specifically, the main CPU 41 judges whether or not an input signal has been received, the signal being output from the start switch 23S when the start button 23 is pushed. The routine returns to step S404 in a case where the main CPU 41 judges that the start button 23 has not been set to ON (step S404: NO). The routine proceeds to step S405 in a case where the main CPU 41 judges that the start button has been set to ON (Step S404: YES).

Next, at step S405, the main CPU 41 performs an effect image displaying process. Specifically, the main CPU 41 displays the free game number display images 90a to 90c corresponding to the free game number on the upper image display panel 33 (see FIG. 14A).

Next, at step S406, the main CPU41 performs a symbol rearrangement process. Specifically, the main CPU 41 executes the program stored in the RAM 43 to sample random numeric values in a numerical range which comes under a predetermined range of random numeric values. The main CPU 41 then compares the sampled random numeric values with a range of random numeric values corresponding to the symbols, thereby determining at random the symbols rearranged in the symbol matrix SM displayed on the lower image display panel 16. The main CPU 41 then performs a symbol scroll-display stopping process based upon the determined symbols.

Next, at step S407, the main CPU 41 judges whether or not the prize has been established. Specifically, the main CPU 41 judges whether or not the predetermined number (for example, three) or more of symbols of the same type are rearranged in the symbol matrix SM. Upon judging that the prize has been established (S407: YES), the main CPU 41 calculates a payout corresponding to the amount set for the number of symbols and the bet amount. The above calculation of a payout is not limitative and includes calculation of a payout such that a predetermined multiple number (for example, three) is determined, based upon which calculation, (three multiplied by the bet amount) multiplied by three, is made to determine a payout in a case where three symbols of the same type are displayed in a stopped state.

Next, at step S408, the main CPU 41 performs a coin payout process based upon the payout determined by the calculation at step S407. In a case where the coins are deposited, the main CPU 41 performs a process of adding the amount of coins to be paid out to the credit amount stored in the RAM 43. Further, in a case of paying the coins out, the main CPU 41 pays out the predetermined amount of coins by transmitting a control signal to the hopper 66.

Next, at step S409, the main CPU 41 sets the remaining number of times in executing the free game, i.e., the remaining free game number to B=B−1. Specifically, the main CPU 41 sets B=B−1 at a value of the remaining free game number B stored in the RAM 43, after completion of a process at step S408.

Next, at step S410, the main CPU 41 judges whether or not the plurality of pieces are combined with one another on the symbol matrix SM to be displayed in combination making up the single picture (the second picture). In a case where the main CPU 41 judges that the plurality of pieces are displayed in combination making up the single picture (the second picture) (S410: YES), the routine returns to step S401. In a case where the main CPU 41 judges that the plurality of pieces are not displayed in combination making up the single picture (the second picture) (S410: NO), the routine proceeds to step S411.

Next, at step S411, the main CPU 41 then judges whether or not a value of the remaining free game number B is equal to zero. Specifically, the main CPU 41 judges whether or not a value of the remaining game number stored in the RAM 43 is equal to zero. In a case where the main CPU 41 judges that the value of the remaining free game number B is not zero (step S411: NO), the routine returns to step S404. On the other hand, in a case where the main CPU 41 judges the value of B is equal to zero (S411: YES), the routine proceeds to step S412.

Next, at step S412, the main CPU 41 performs a payout process. Specifically, the main CPU 41 awards a payout stored in the RAM 43 during an interval from completion of the free game to restart of the basic game. The main CPU 41 then terminates the free game execution process.

While, in the above-described embodiment, the partial pieces making up the single picture are drawn as the background of the symbols, the present invention is not limited thereto. Those partial pieces may be drawn as the foreground. Incidentally, one example in this case will be described hereinafter.

A slot machine according to another embodiment includes (i) a plurality of mechanical reels on which plural types of symbols are drawn; (ii) a liquid crystal display device disposed on front surfaces of the plurality of mechanical reels so as to transparently display the symbols and a plurality of partial pieces making up a single picture are drawn as a foreground of the symbols; (iii) a memory for storing image data concerning the plurality of pieces making up a first picture intended for determining winning establishment of a special prize, and image data concerning the plurality of pieces making up a second picture intended for determining type of the special prize; and (iv) a controller.

The controller (iv) is configured to perform processes as described below. The controller (iv) is configured to (a) read out of the memory, the image data concerning the plurality of pieces making up the first picture; (b) variably display the plurality of mechanical reels in a first direction; and (c) variably display the plurality of pieces in the first direction on the liquid crystal display device. The controller (iv) is also configured to (d) award a payout based upon a predetermined combination, in a case where a judgment is made that the symbols rearranged on the liquid crystal display device establish the predetermined combination. The controller (iv) is further configured to (e) determine the winning establishment of the special prize, in a case where a judgment is made that the plurality of pieces drawn as the foreground of the symbols rearranged on the liquid crystal display device are combined with one another to make up the first picture. The controller (iv) is yet further configured to (f) read out of the memory, the image data concerning the plurality of pieces making up the second picture; and (g) variably display in a second direction different from the first direction, the plurality of pieces on the liquid crystal display device. Also, the controller (iv) is configured to (h) determine the type of the special prize in accordance with the second picture, in a case where a judgment is made that the plurality of pieces rearranged on the liquid crystal display device are combined with one another on the liquid crystal display device to make up the second picture. Finally, the controller (iv) is configured to (h) determine the type of the special prize in accordance with the second picture, in a case where a judgment is made that the plurality of pieces rearranged on the liquid crystal display device are combined with one another on the liquid crystal display device to make up the second picture.

### Second Embodiment

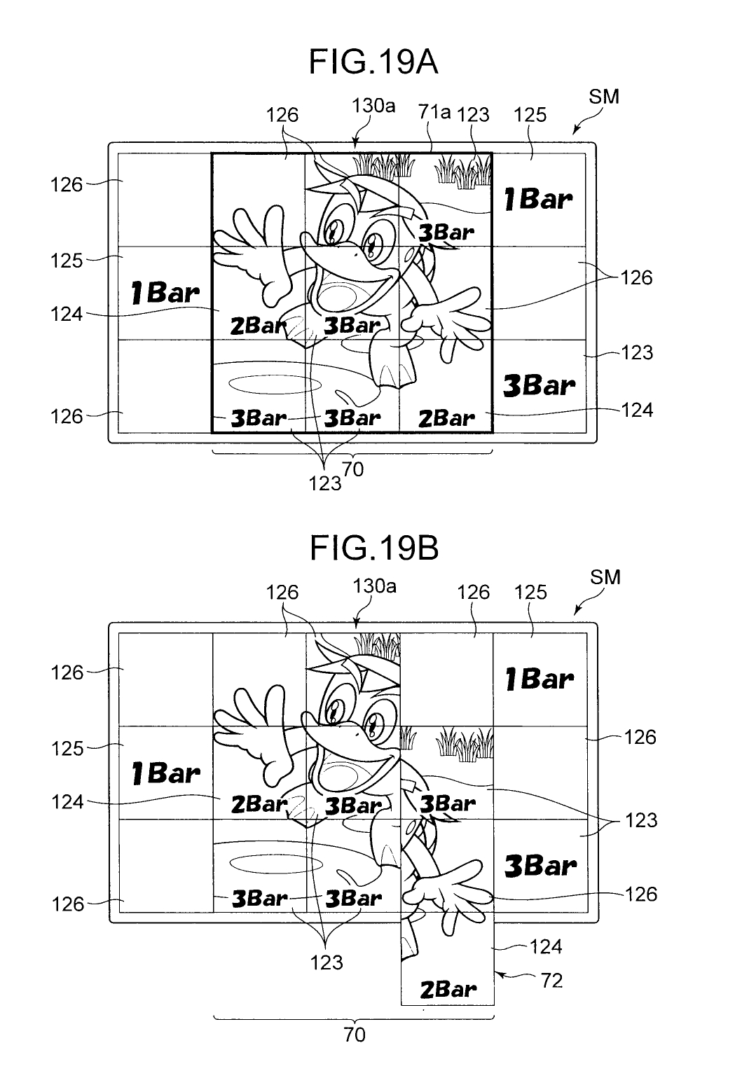

A slot machine 10 according to an embodiment will be described in detail with reference to the drawings. FIGS. 19A and 19B are views each showing an exemplary display screen according to the embodiment. As shown in FIGS. 19A and 19B, a display device included in the slot machine 10 displays plural types of symbols and a plurality of background images that are drawn as backgrounds of the symbols and make up a single complete image.

The plurality of background images stored in the RAM 43 include a plurality of background images making up a first complete image for entry into a free game as a special prize, and a plurality of background images making up a second complete image for entry into a jackpot bonus game as a special payout during the free game.

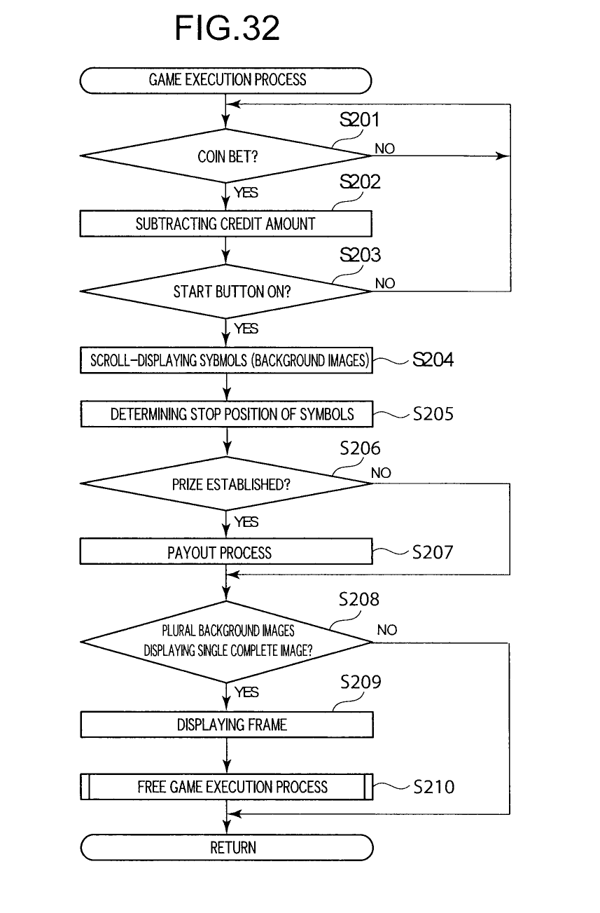

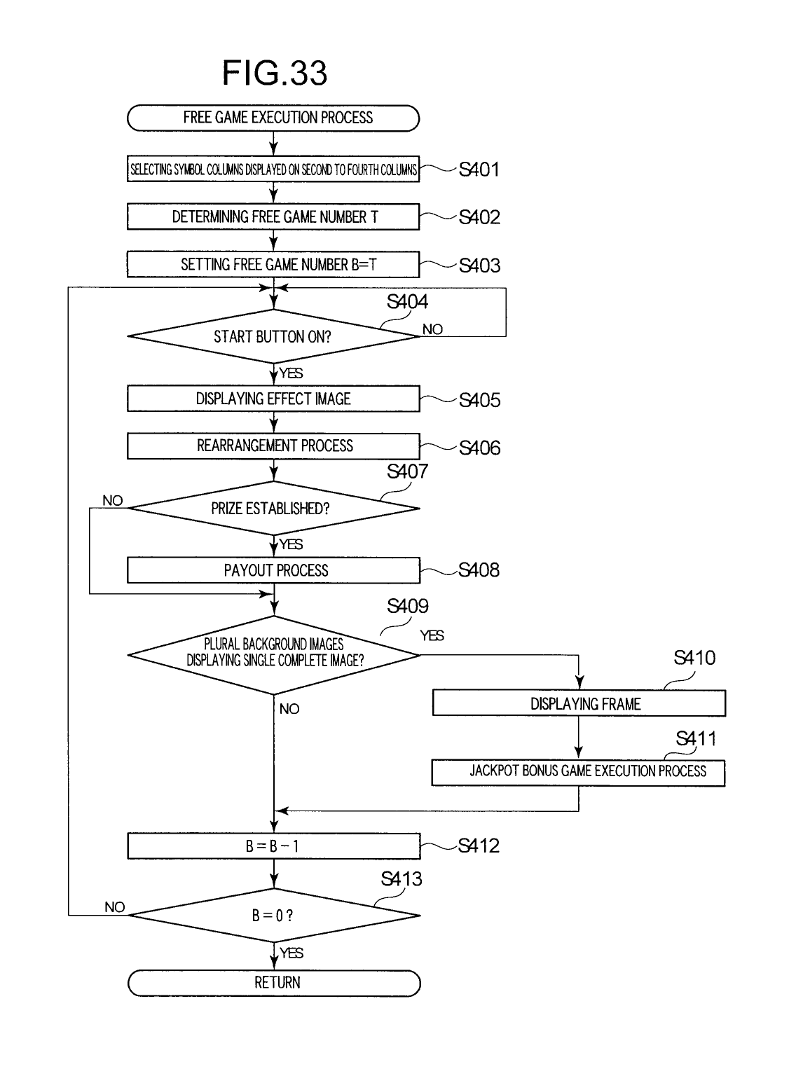

The main CPU 41 included in the slot machine 10 executes a following process upon acceptance of an input signal from a start button after coins are bet (see FIGS. 32 and 33). The main CPU 41 randomly determines the plural types of symbols to be rearranged on the display device (S205).

The main CPU 41 reads out the plurality of background images making up the first complete image, from the RAM 43. The main CPU 41 rearranges on the display device, the randomly-determined plural types of symbols and the plurality of background images making up the first complete image drawn as the backgrounds of the symbols.

In a case where the symbols rearranged on the display device form a predetermined combination (three or more symbols of the same type), the main CPU 41 awards a payout based on the rearranged symbols (S205). For example, the five symbols of the same type “3Bar” are arranged as shown in FIG. 19B, so that the main CPU 41 awards a predetermined payout based on this combination.

The main CPU 41 then judges whether or not the plurality of background images drawn as the backgrounds of the symbols rearranged on the display device are displayed in combination making up the single first complete image (S207). As a result, upon judging that the plurality of background images drawn as the backgrounds of the symbols make up the single first complete image (see FIG. 19A), the main CPU 41 executes a free game (a special game) as a special prize (S208).

When the game enters into the free game, the main CPU 41 reads out the plurality of background images making up the second complete image from the RAM 43. The main CPU 41 rearranges on the display device, the randomly-determined plural types of symbols and the plurality of background images making up the second complete image drawn as the backgrounds of the symbols (S406).

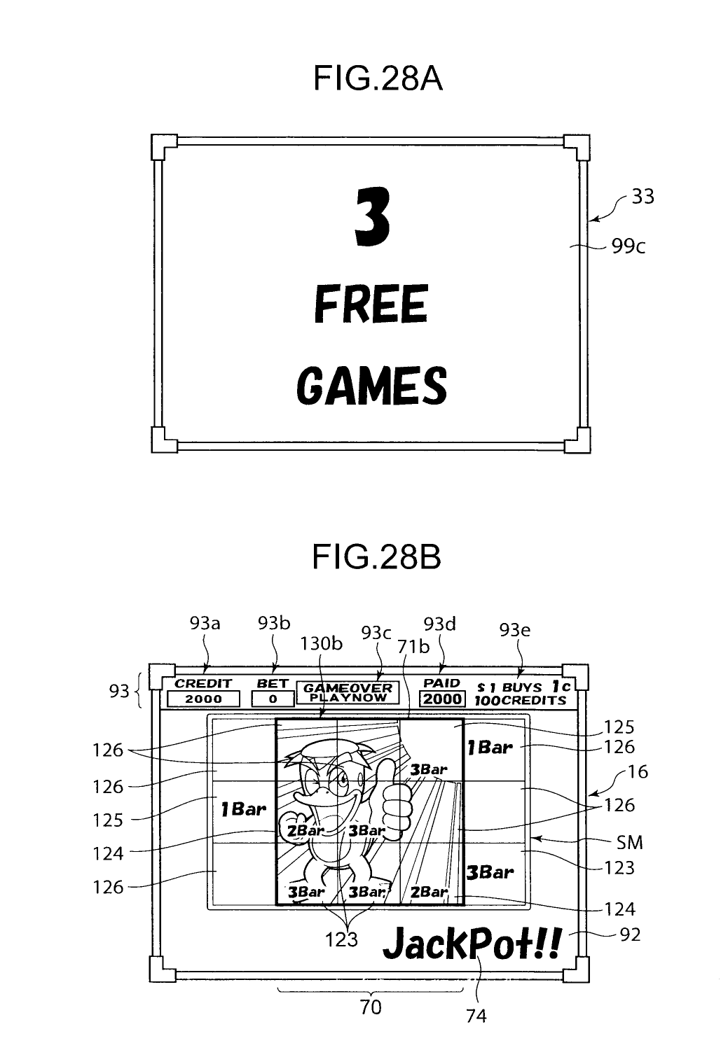

Upon judging that the plurality of background images drawn as the backgrounds of the symbols are displayed on the display device in combination making up the single second complete image (FIG. 28B, S409: YES), the main CPU 41randomly determines rank of a progressive jackpot bonus. The main CPU 41 awards the progressive jackpot bonus game as a special payout based on the determined rank (S411).

As described above, in the slot machine according to this embodiment, the plurality of background images making up the first complete image and the plurality of background images making up the second complete image are drawn as the backgrounds of the plural types of symbols. The game enters into the free game in a case where the plurality of background images drawn as the backgrounds of the symbols are displayed in combination making up the single first complete image as a result of rearrangement of the plurality of symbols during the basic game. The game enters into the progressive jackpot bonus game in a case where the plurality of background images drawn as the backgrounds of the symbols are displayed in combination making up the single second complete image as a result of rearrangement of the plurality of symbols during the free game.

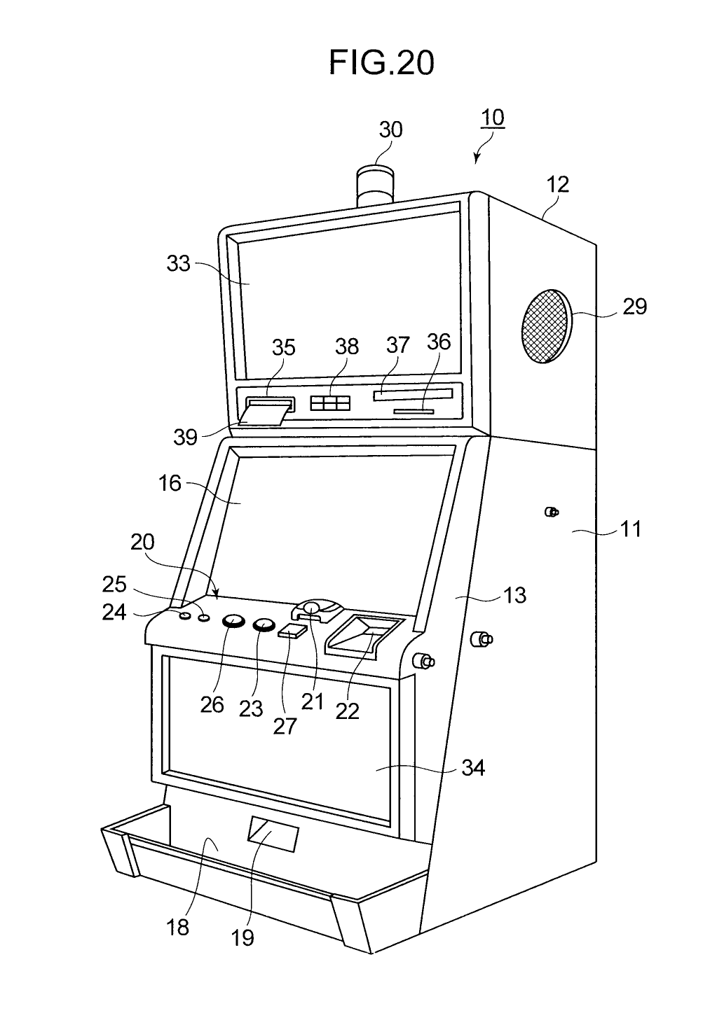

FIG. 20 is a perspective view schematically showing a frame format of a slot machine according to the embodiment of the present invention. While the slot machine 10 is of a stand-alone type, which is not connected to a network, the present invention is also applicable to a networked slot machine.

The basic game is executed upon consumption of a gaming value corresponding to the amount bet by a player. The free game is executed without consumption of a gaming value, in a case where the background images rearranged in an image display region during the basic game are rearranged in combination displaying the complete image. The jackpot bonus game is to award a special payout in a case where the background images rearranged during the free game are displayed in combination making up the complete image.

The gaming media used in the slot machine 10 include coins, bills, or electronic value information equivalent thereto. In the present invention, however, medals, tokens, electronic money, or tickets, for example, may be employed as gaming mediums without being limitative thereto in particular. The above tickets are not limitative in particular, and can include barcode-attached tickets or the like, as described later, for example.

The slot machine 10 is provided with: a cabinet 11; a top box 12 installed at an upper side of the cabinet 11; and a main door 13 provided at a front face of the cabinet 11.

A lower image display panel 16 serving as a display device is provided in front of the main door 13. The lower image display panel 16 is provided with a liquid crystal panel, which displays the symbol matrix SM with a total of fifteen display cells in three rows and five columns. The single symbol is arranged in each display cell of the symbol matrix SM.

The plurality of background images making up the single complete image are displayed in an image display region 70 provided at part of the symbol matrix SM. The plurality of background images are drawn as the backgrounds of the plurality of symbols, thereby being displayed in accordance with display of the plural types of symbols in a stopped state.

Downwardly of the lower image display panel 16, a control panel 20 including a plurality of buttons 23 to 27 for entering instructions pertinent to the progress of a game by a player; a coin insertion slot 21 for accepting coins in the cabinet 11; and a bill validator 22 are provided.

On the control panel 20, a start button 23, a change button 24, a cashout button 25, a 1-BET button 26, and a max-BET button 27 are provided. The start button 23 is intended for entering a command for starting the game. The change button 24 is intended for use in asking an attendant of the gaming facility for change. The cashout button 25 is intended for entering a command for paying the credited coins to a coin tray 18 through a coin payout exit 19.

The 1-BET button 26 is intended for entering a command for betting one coin among the credited coins on the game. The max-BET button 27 is intended for entering a command for betting the upper number (50 in this embodiment) of coins that can be bet per game among the credited coins on the game.

The bill validator 22 validates whether or not a bill is legitimate and accepts a legitimate bill into the cabinet 11. The bill validator 22 may be configured so that a barcode-attached ticket 39 described later is readable thereby. Provided on a lower front surface of the main door 13, that is, at a lower part of the control panel 20, is a berry glass 34 on which characters of the slot machine 10 and the like are depicted.

On a front face of the top box 12, an upper image display panel 33 is provided. The upper image display panel 33 has a liquid crystal panel, which displays images for introducing the game contents or explaining game rules, for example. Upon start of the free game, the liquid crystal panel displays an image indicative of the remaining number of times in executing the free game.

Also, on the top box 12, a lamp 30 and a speaker 29 are provided. At the lower side of the upper image display panel 33, a ticket printer 35, a card reader 36, a data display unit 37, and a keypad 38 are provided. The ticket printer 35 prints, on tickets, bar codes containing coded data such as the credit amount, date and time, or ID numbers of the slot machine 10, and the barcode-attached tickets 39 are output. A player causes another slot machine to read the bar-code-attached tickets 39, allowing the slot machine to perform games, or alternatively, allowing the exchange of barcode-attached tickets 39 with bills or the like at a predetermined site of a game facility (for example, at the casher in a casino).

The card reader 36 reads data from and writes data into a smart card. The smart card is to be owned by the player, which stores data for identifying the player or data regarding the log of games executed by the player, for example. The smart card may store data equivalent to coins, bills, or credits. As an alternative of a smart card, a magnetic stripe card may be employed. The data display unit 37 is made up of a fluorescent display or the like, and stores data read by the card reader 36 or data input by the player via the keypad 38, for example. The keypad 38 is intended for entering the instructions or data pertinent to the issuance of tickets.

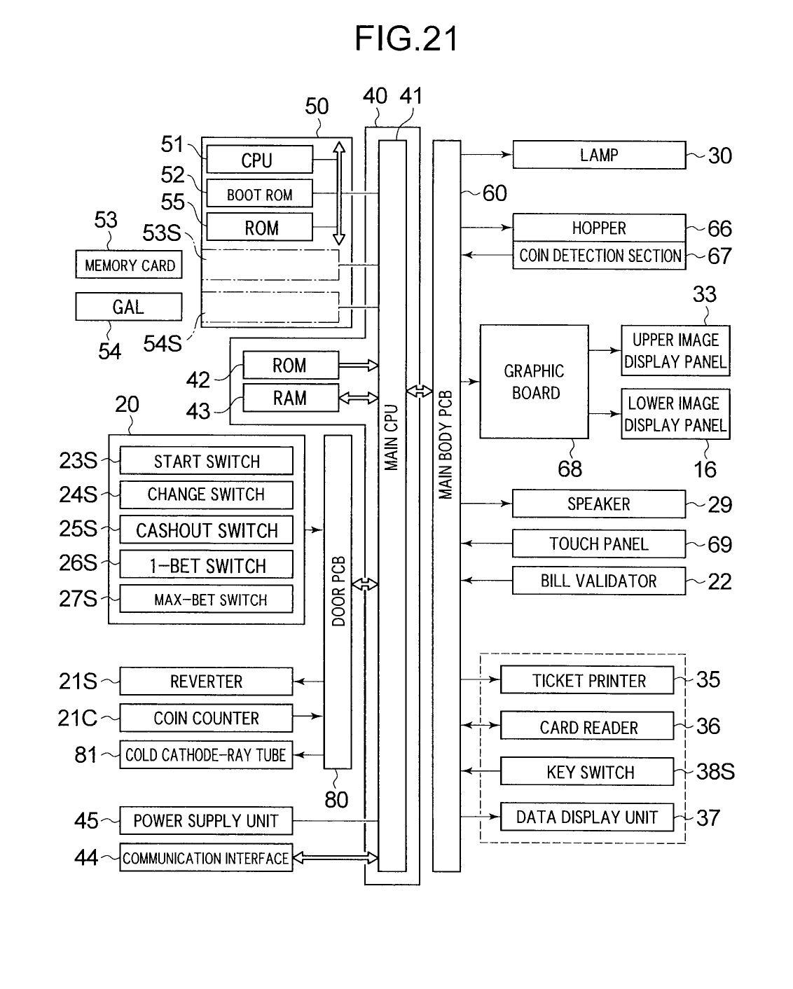

FIG. 21 is a view showing an internal construction of the slot machine shown in FIG. 20. A gaming board 50 includes: a CPU (Central Processing Unit) 51, a ROM (Read-only Memory) 55 and a boot ROM 52 interconnected by an internal bus; a card slot 53S corresponding to a memory card 53; and an IC socket 54S corresponding to a GAL (Generic Array Logic) 54.

The memory card 53 is made up of non-volatile memories such as CompactFlash (registered trademark), and stores game programs. The game programs include a symbol selection program, a background image selection program, and the like. The symbol selection program is a program used to determine symbols to be rearranged in the symbol matrix SM. The background image selection program is used to determine background images to be rearranged in the image display region.

A payout ratio is to be determined based on payout ratio setting data to be output from the GAL 54. Further, the game programs include table data indicating a correspondence relationship between each of the symbols and a payout.

In addition, a card slot 53S is constituted to enable removable insertion of the memory card 53, and is connected to a motherboard 40 by means of an IDE bus. Therefore, the memory card 53 is removed from the card slot 53S, other game programs and game system programs are written into the memory card 53, and thereafter, the memory card 53 is inserted into the card slot 53S, thereby making it possible to vary the kinds or contents of the games performed at the slot machine 10. The game programs include those which are relevant to the operating procedures for performing games. Furthermore, the game program includes image data or sound data to be output during the game. The image data includes one intended to display the symbol matrix SM.

The GAL 54 is a kind of PLD (Programmable Logic Device) having an OR-fixed arrayed structure. The GAL 54 is provided with a plurality of IN ports and OUT ports. If predetermined items of data are input into the IN port, the corresponding data is output from the OUT port. In addition, an IC socket 54S is constituted to allow detachable attachment thereto of the GAL 54, and is connected to a motherboard 40 by means of a PCI bus.

The CPU51, the ROM55, and the boot ROM52 interconnected via the internal bus are connected to the motherboard 40 via a PCI bus. The PCI bus not only performs signal transmission between the motherboard 40 and the gaming board 50, but also supplies power from the motherboard 40 to the gaming board 50.

The motherboard 40 is constructed using a general-purpose motherboard commercially available (a printed circuit board on which essential parts of a personal computer are mounted) and includes: a main CPU (Central Processing Unit) 41, a ROM (Read-only Memory) 42; a RAM (Random Access Memory) 43; and a communication interface 44. The main CPU 41 functions as a processor for controlling a display device and memory according to the embodiment of the present invention.

The ROM42 is made up of a memory device such as a flash memory, and stores a program such as a BIOS (Basic Input/Output System) executed by the main CPU41 and permanent data.

When the BIOS is executed by the main CPU 41, processing of initializing predetermined peripheral devices is carried out and processing of capturing game programs and game system programs stored in the memory card 53 through the gaming board 50 is started. In embodiments of the present invention, the contents of the ROM 42 may be rewritable or not.

The RAM 43 stores data and programs used when the main CPU 41 is activated. The RAM 43 can also store game programs. Further, the RAM 43 stores the data pertinent to credit amounts and coin insertion numbers or payout numbers in one game.

Each of a body PCB (Printed Circuit Board) 60 and a door PCB 80, which will be described later, are connected to the motherboard 40 by a USB. A power supply unit 45 is also connected to the motherboard 40.

To the main body PCB 60 and the door PCB 80, equipment or devices, for generating an input signal input to the main CPU 41, and those of which operation is controlled by means of a control signal output from the main CPU 41, are connected. The main CPU 41 executes the game programs stored in RAM 43, based on an input signal that was input to the main CPU 41, thereby performing a predetermined computational process. Then, this CPU 41 stores results thereof into RAM43; and transmits control signals to equipment and devices as a control process relative to the equipment and devices.

Connected to the main body PCB 60 are a lamp 30, a hopper 66, a coin detection section 67, a graphic board 68, a speaker 29, a touch panel 69, a bill validator 22, a ticket printer 35, a card reader 36, a key switch 38S, and a data display unit 37. The lamp 30 lights in a predetermined pattern, based on a control signal output from the main CPU 41.

The hopper 66 is installed in a cabinet 11, and the predetermined number of coins are paid out from the coin payout opening 19 to the coin tray 18, based on the control signal output from the main CPU 41. The coin detection section 67 is provided inside of the coin payout opening 19, and outputs an input signal to the main CPU 41, if it is detected that a predetermined number of coins have been paid out from the coin payout opening 19.

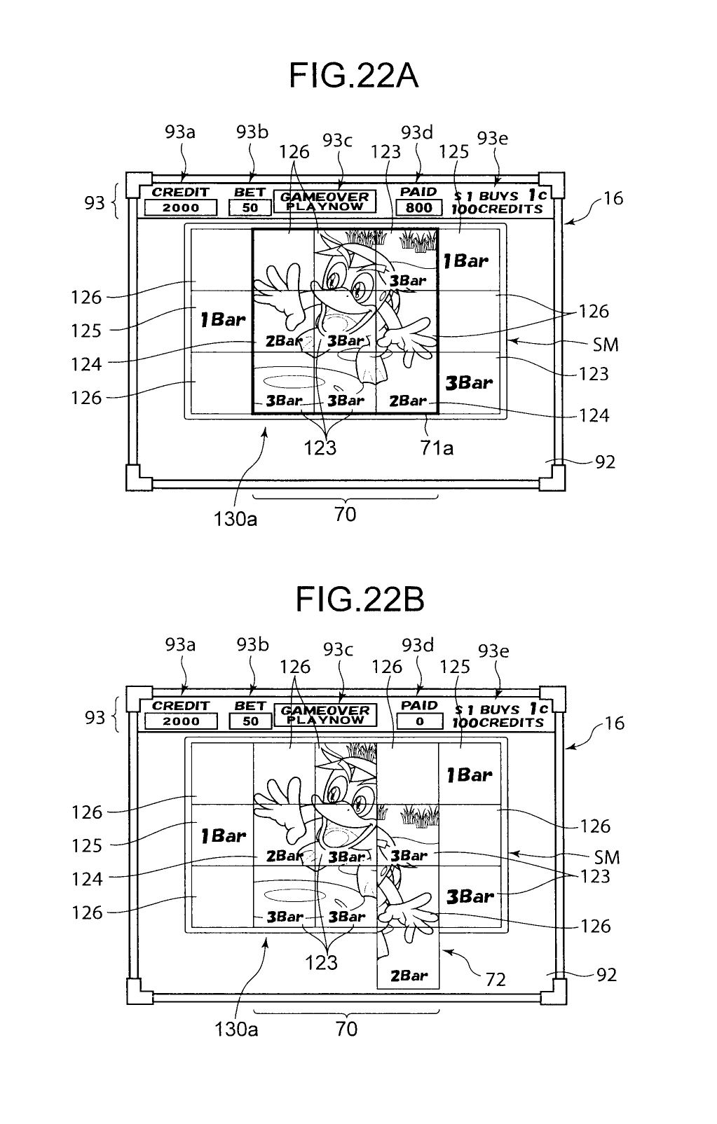

A graphic board 68 controls the images to be displayed on the upper and lower image display panels 33, 16, based on the control signal output from the main CPU 41. A credit amount display section 93a of the lower image display panel 16 (see FIGS. 22A and 22B) displays the amount of credits stored in the RAM 43. The amount of paid-out coins is displayed in a PAID amount display section 93d of the lower image display panel 16 (see FIGS. 22A and 22B).

The graphic board 68 is provided with: a VDP (Video Display Processor), which generates image data, based on the control signal output from the main CPU 41; and video RAM, etc., which temporarily stores image data generated by video image ROM, video image RAM, and the VDP. The graphic board 68 reads out the image data from the video image ROM based on the determined contents, thereby forming and outputting the image based on the read out data, to the upper image display panel 33 and the lower image display panel 16. The upper image display panel 33 and the lower image display panel 16 display the input video images.

The video image RAM temporarily stores the data used when the VDP is operated. The video image ROM stores the data concerning the plurality of background images making up the first and second complete images. It also stores the symbol image data to be displayed in the symbol matrix SM. The video image RAM is provided with a memory region storing the symbol image data and a memory region storing the background image data.

The VDP forms video images by superimposing images of data read the memory regions, and then, outputs the resultant images to each of the display panels 16, 33. Therefore, the image display region 70 displays the plurality of background images as if they are drawn as the backgrounds of the plural types of symbols. The image data employed when the image data is generated by means of the VDP is read from the memory card 53, and thereafter, is included in the game programs stored in the RAM 43.

The speaker 29 outputs sound such as BGM in accordance with sound data output from the main CPU 41. The touch panel 69 is disposed on a front surface of the lower image display panel 16, which enables players to operate the touch panel 69 to input various instructions.

The bill validator 22 validates whether or not a bill is legitimate and accepts a legitimate bill into the cabinet 11. The bill validator 22, upon accepting a legitimate bill, outputs an input signal to the main CPU 41 based on the bill amount. The main CPU 41 stores in the RAM 43 the amount of credits responsive to that of bills transmitted by the input signal.

Based on a control signal output from the main CPU 41, the ticket printer 35 prints on a ticket a barcode having encoded thereon data such as the credit amount, data and time, and the identification number of the slot machine 10 stored in the RAM 43. Further, this printer outputs the printed ticket as a barcode-attached ticket 39. The card reader 36 reads data from a smart card, thereby transmitting the read data to the main CPU 41 or writing data into the smart card, based on the control signal from the main CPU 41. The key switch 38S is provided on the key pad 38, and outputs a predetermined input signal to the main CPU 41 when a player operates the key pad 38. The data display unit 37 displays, based on a control signal output from the main CPU 41, the data read by the card reader 36 and the data input by a player through the key pad 38.

To the door PCB 80, a control panel 20, a reverter 21S, a coin counter 21C, and a cold cathode-ray tube 81 are connected. The control panel 20 is provided with: a start switch 23S corresponding to the start button 23; a change switch 24S corresponding to the change button 24; a cashout switch 25S corresponding to the cashout button 25; a 1-BET switch 26S corresponding to the 1-BET button 26; and a max-BET switch 27S corresponding to the max-BET button 27. The switches 23S to 27S output input signals to the main CPU 41 when the player operates the corresponding buttons 23 to 27.

The coin counter 21C is provided inside the coin receiving slot 21, and validates whether or not a legitimate coin is inserted into the coin receiving slot 21. Those other than the legitimate coins are discharged from the coin payout exit 19. The coin counter 21C outputs an input signal to the main CPU 41 when a legitimate coin is detected.

The reverter 21 S is operable based on the control signal output from the main CPU 41. This reverter distributes the coins recognized to be legitimate by the coin counter 21C, into a cashbox (not shown) or a hopper 66 which was installed in the slot machine 10. In other words, if the hopper 66 is filled with coins, the legitimate coins are distributed to the cashbox by means of the reverter 21 S. Otherwise, the legitimate coins are distributed to the hopper 66. The cold cathode-ray tube 81 functions as a backlight installed at the rear side of the lower and upper image display panels 16, 33, and lights based on the control signal that was output from the main CPU 41.

FIGS. 22A to 27B are views each showing an exemplary image displayed in the slot machine shown in FIG. 20 according to the embodiment. FIGS. 22A and 22B are views each showing an exemplary symbol matrix SM during the basic game.

As shown in FIG. 22A, the lower image display panel 16 is made up of a display area section 92, an information display section 93, and the like. The display area section 92 is for displaying a symbol matrix SM.

The information display section 93 is arranged upwardly of the display area section 92 and is made up of the credit amount display section 93a, a BET amount display section 93b, a character information display section 93c, the PAID amount display section 93d, and a charge display section 93e.

The number of coins presently credited is displayed at the credit amount display section 93a while the number of coins bet in one game is displayed at the BET amount display section 93b. The character information indicative of a current status of the game is displayed at the character information display section 93c. The characters of “PLAYNOW” are displayed during the play of the game, whereas the characters of “GAMEOVER” are displayed during the intervals between the plays of the game. The number of coins that has been successfully obtained in one game is displayed at the PAID amount display section 93d, whereas a conversion value of the credit amount based on a predetermined charge is displayed at the charge display section 93e.

A total of fifteen symbols are rearranged in five columns and three rows on the symbol matrix SM displayed on the lower image display panel 16. These symbols include symbols “WILD” 121, “7” 122, “3Bar” 123, “2Bar” 124, “1Bar” 125, and “Blank” 126 in the symbol matrix SM.

The symbol columns on the symbol matrix SM include first to fifth symbol columns, in which the image display region 70 is formed in the second to fourth columns. In this image display region 70, the plural types of symbols and the plurality of background images making up the single complete image are displayed such that the image display region 70 performs a composite image of the symbols and the background images so as to draw the background images as the backgrounds of the symbols. A single complete image shown in FIG. 22 is the first complete image and is intended for entry into the free game (the special game) as the special prize during the basic game.

As shown in FIG. 22A, the game enters into the free game as the special prize in a case where the plural types of symbols are rearranged and a plurality of background images 130a are displayed in combination making up the single complete image during the basic game. In this case, the lower image display panel 16 is adjusted with respect to display luminance of the display area section 92 so as to display the image display region 70 with relatively high luminance in whole or in part. In the example shown in FIG. 22A, a frame 71a is displayed with high luminance. The frame 71a is displayed with high luminance so as to be emphatically displayed in comparison to the symbol matrix SM in view of visibility.

As shown in FIG. 22B, in a case where the predetermined number (for example, three) of symbols of the same type from among “WILD” 121, “7” 122, “3Bar” 123, “2Bar” 124, “1Bar” 125, and “Blank” 126 are rearranged in any display cells of the symbol matrix SM during the basic game, a payout is awarded based on the rearranged symbols. The five symbols “3Bar” 123 are rearranged in the example shown in FIG. 22B, so that a payout corresponding to a combination of the five symbols “3Bar” is to be awarded.

As shown in FIG. 22B, in a case where the first to third and fifth symbol arrays are rearranged in sequence, the fourth symbol column can be rearranged at the last. Herein, in a case where the plurality of background images on the fourth symbol column rearranged at the last are not displayed in combination making up the single complete image together with the plurality of background images on the second and third symbol columns, an image 72 of the symbol array disposed on the fourth column is displayed so as to be misaligned by one frame from the screen.

In a case where the plurality of background images on the second to fourth symbol columns make up the single complete image (see FIG. 22A), or the plurality of background images on the second and third columns make up the incomplete image (see FIG. 22B), the symbols on the second to fourth columns can be displayed in a scaled down manner so as to facilitate visual recognition of the plurality of background images 130a thereon.

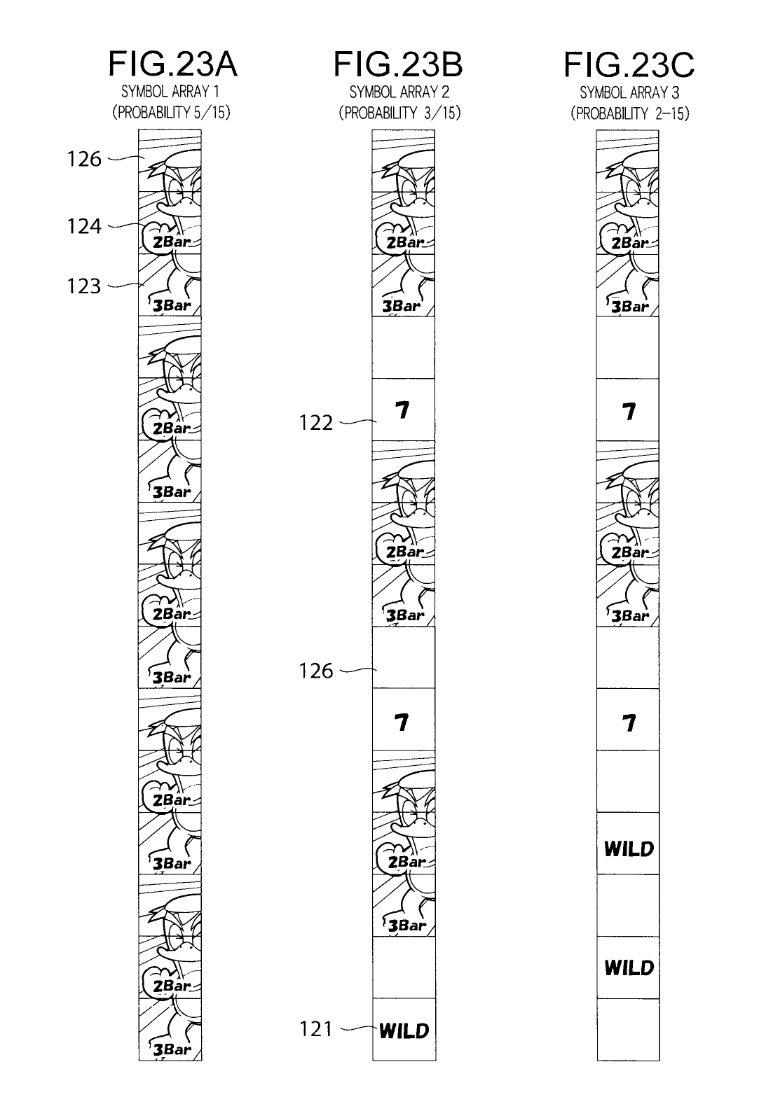

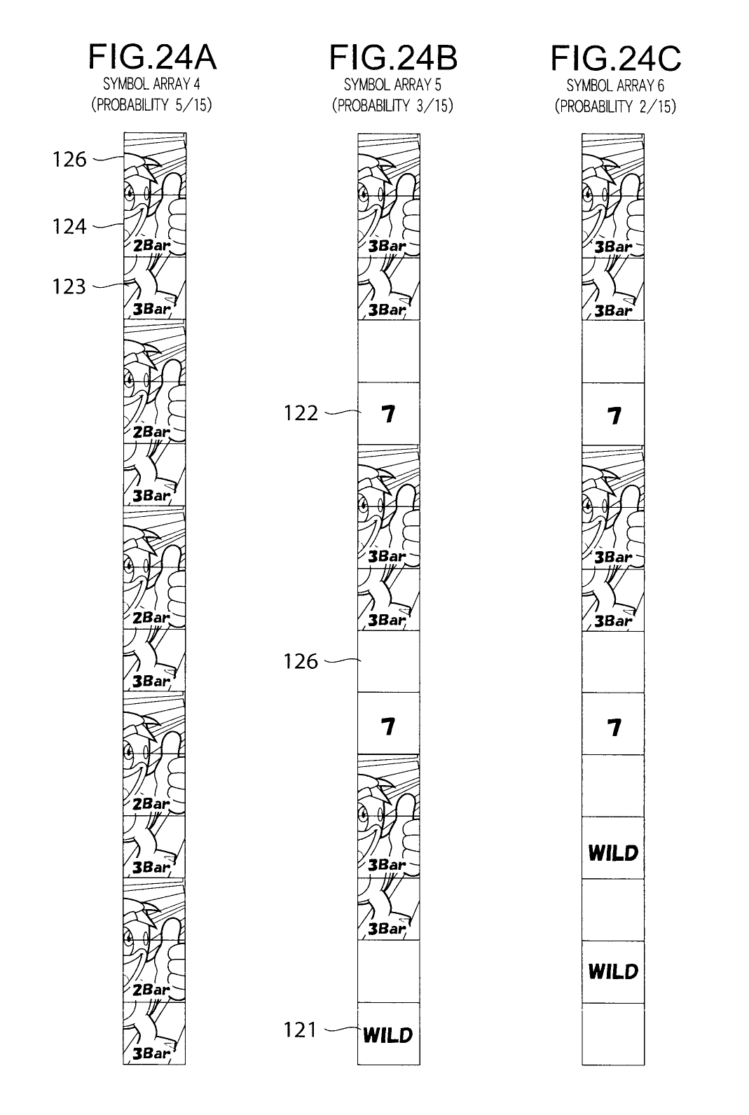

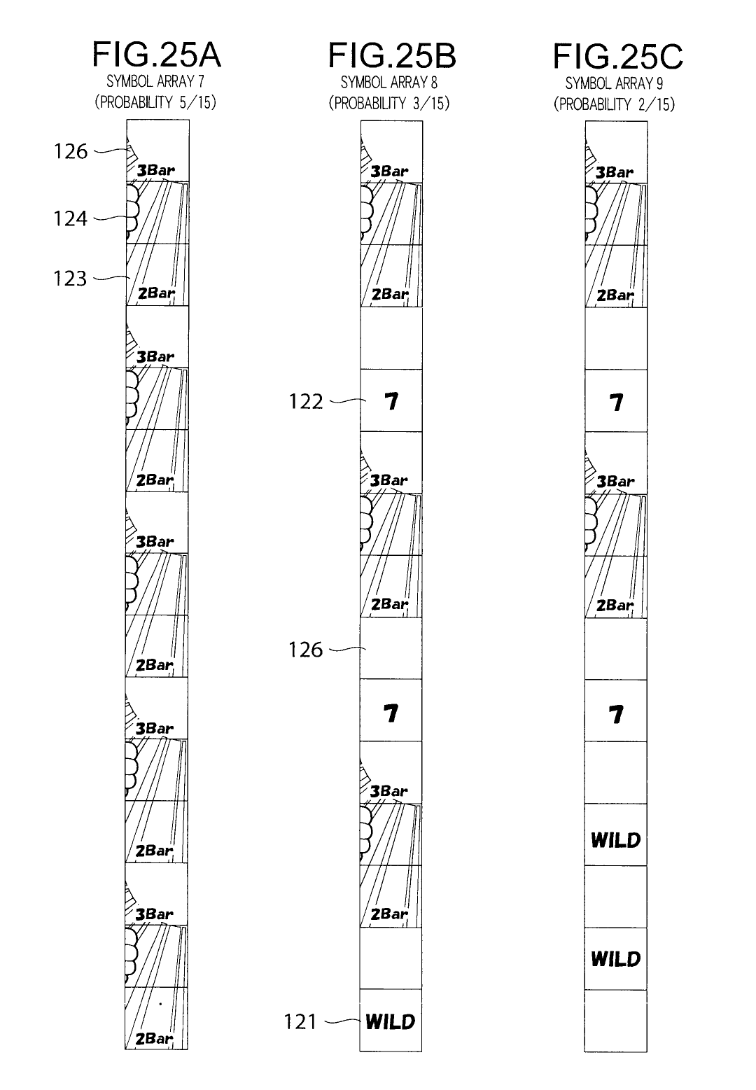

FIGS. 23A to 25C are views each showing plural types of symbol arrays during the free game. FIG. 23A to 23B are views each showing a symbol array on the second column during the free game. FIGS. 24A to 24C are views each showing a symbol array on the third column during the free game. FIGS. 25A to 25C are views each showing a symbol array on the fourth column during the free game.

As shown in FIGS. 23A to 25C, the symbols from among “WILD” 121, “7” 122, “3Bar” 123, “2Bar” 124, “1Bar” 125, and “Blank” 126 are drawn on the second to fourth reels. The background images that make up the single complete image are drawn as the backgrounds of the symbols. The single complete image shown in FIGS. 23A to 25C is the second complete image to be displayed during the free game. Upon display of the second complete image during the free game, the game enters into the progressive jackpot bonus game.

FIG. 23A is a view showing a symbol array 1 on the second column during the free game. As shown in FIG. 23A, fifteen stopping patterns include five stopping patterns in which the continuous background images making up part of the single complete picture stop within frames of the second column. This means that 5/15 is the probability that this array is displayed so that the background images arranged thereon make up part of the single complete image.

FIG. 23B is a view showing a symbol array 2 on the second column during the free game. As shown in FIG. 23B, fifteen stopping patterns include three stopping patterns in which the continuous background images making up part of the single complete picture stop within frames of the second column. This means that 3/15 is the probability that this array is displayed so that the background images arranged thereon make up part of the single complete image.

FIG. 23C is a view showing a symbol array 3 on the second column during the free game. As shown in FIG. 23C, fifteen stopping patterns include two stopping patterns in which the continuous background images making up part of the single complete picture stop within frames of the second column. This means that 2/15 is the probability that this array is displayed so that the background images arranged thereon make up part of the single complete image.

FIG. 24A is a view showing a symbol array 4 on the third column during the free game. As shown in FIG. 24A, fifteen stopping patterns include five stopping patterns in which the continuous background images making up part of the single complete picture stop within frames of the third column. This means that 5/15 is the probability that this array is displayed so that the background images arranged thereon make up part of the single complete image.

FIG. 24B is a view showing a symbol array 5 on the third column during the free game. As shown in FIG. 24B, fifteen stopping patterns include three stopping patterns in which the continuous background images making up part of the single complete picture stop within frames of the third column. This means that 3/15 is the probability that this array is displayed so that the background images arranged thereon make up part of the single complete image.

FIG. 24C is a view showing a symbol array 6 on the third column during the free game. As shown in FIG. 24C, fifteen stopping patterns include two stopping patterns in which the continuous background images making up part of the single complete picture stop within frames of the third column. This means that 2/15 is the probability that this array is displayed so that the background images arranged thereon make up part of the single complete image.

FIG. 25A is a view showing a symbol array 7 on the fourth column during the free game. As shown in FIG. 25A, fifteen stopping patterns include five stopping patterns in which the continuous background images making up part of the single complete picture stop within frames of the fourth column. This means that 5/15 is the probability that this array is displayed so that the background images arranged thereon make up part of the single complete image.

FIG. 25B is a view showing a symbol array 8 on the fourth column during the free game. As shown in FIG. 25B, fifteen stopping patterns include three stopping patterns in which the continuous background images making up part of the single complete picture stop within frames of the fourth column. This means that 3/15 is the probability that this array is displayed so that the background images arranged thereon make up part of the single complete image.

FIG. 25C is a view showing a symbol array 9 on the fourth column during the free game. As shown in FIG. 25C, fifteen stopping patterns include two stopping patterns in which the continuous background images making up part of the single complete picture stop within frames of the fourth column. This means that 2/15 is the probability that this array is displayed so that the background images arranged thereon make up part of the single complete image.

In the free game, the symbol arrays on the second to fourth columns are determined as described below. A symbol array on the second column is determined at random from among the symbol arrays 1 to 3 shown in FIGS. 23A to 23C. A symbol array on the third column is determined at random from among the symbol arrays 4 to 6 shown in FIGS. 24A to 24C. A symbol array on the fourth column is determined at random from among the symbol arrays 7 to 9 shown in FIGS. 25A to 25C.

For example, let us assume that the symbol array 1 of FIG. 23A is set to the array on the second column; the symbol array 5 of FIG. 24B is set to the array on the third column; and the symbol array 9 of FIG. 25C is set to the array on the fourth column. In this assumption, the probability that the plurality of background images are displayed to make up the single complete picture is set to be equal to 2/225 determined by the formula of (5/15)×(3/15)×(2/15). That is, the probability of entry into the progressive jackpot bonus game changes depending on arrays selected as those which are disposed on the second to fourth symbol columns. Incidentally, the plurality of background images drawn on the symbol arrays on the second to fourth columns during the basic game are different from those which are displayed during the free game.

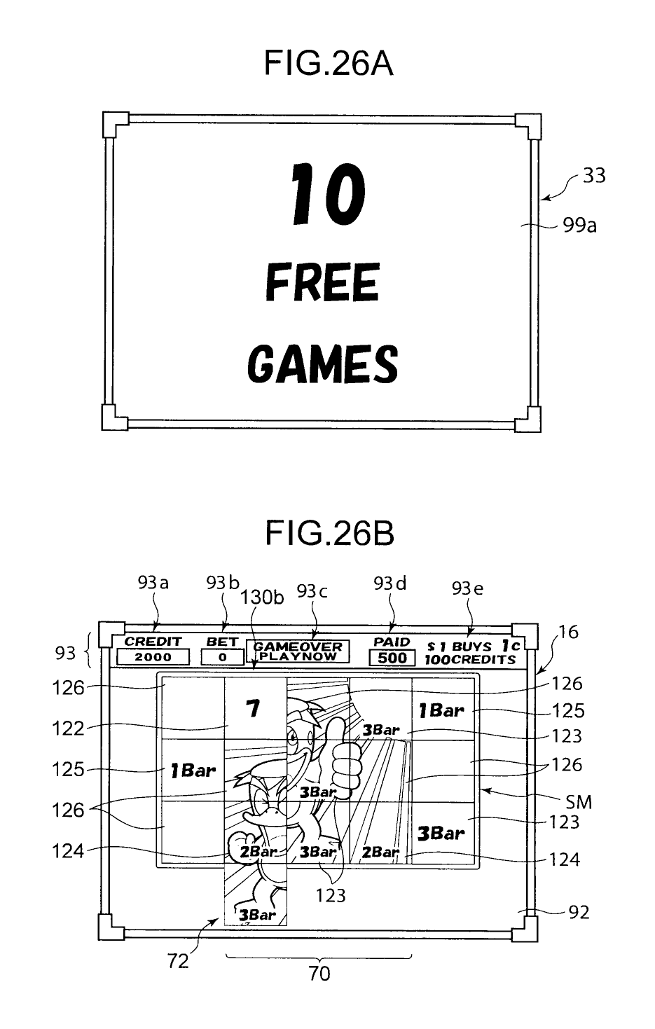

FIGS. 26A and 26B are views each showing an exemplary image displayed in the slot machine shown in FIG. 20, during the free game. As shown in FIG. 26A, upon start of the free game, the upper image display panel 33 displays the free-game-number display image 99a indicative of the remaining number of times in executing the free game. In this example, upon start of the free game, the free-game-number display image 99a such as “10 FREE GAMES” is displayed which indicates that ten free games remain, for example.

As shown in FIG. 26B, the symbol matrix SM is displayed in the display area section 92 of the lower image display panel 16, in which any combination of symbols “WILD” 121, “7” 122, “3Bar” 123, “2Bar” 124, “1Bar” 125, and “Blank” 126 is rearranged in any display cells.

The plurality of background images different from those which are set for the basic game are displayed in the image display region 70 provided at part of the symbol matrix SM. As shown in FIG. 26B, the plurality of background images 130b are not displayed in combination making up the single complete image because an image 72 is displayed, in which the background images 130b on the second column are shifted by one frame. Therefore, the basic game is continued without execution of the free game.

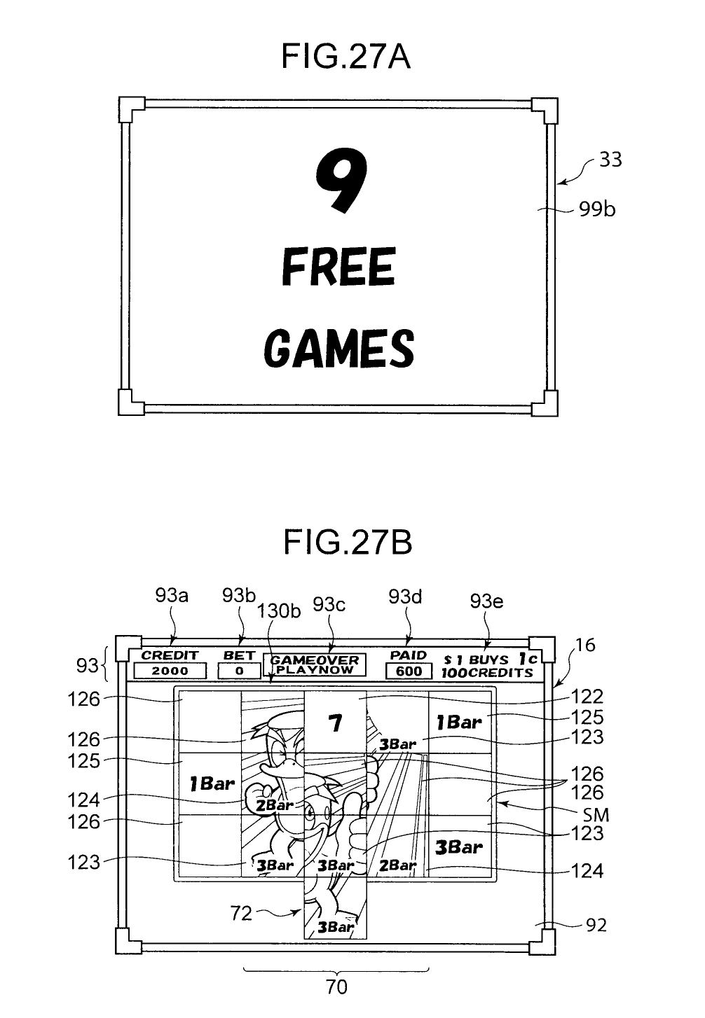

FIGS. 27A and 27B are views each showing an exemplary image displayed in the slot machine shown in FIG. 20, during the free game. As shown in FIG. 27A, the upper image display panel 33 displays a free-game-number display image 99b indicative of the remaining number of times in executing the free game. One free game is executed in this example, so that the free-game-number display image 99b such as “9 FREE GAMES” is displayed, which indicates that nine more free games remain, for example.

As shown in FIG. 27B, the display area section 92 of the lower image display panel 16 displays the symbol matrix SM, in which any combination of symbols “WILD” 121, “7” 122, “3Bar” 123, “2Bar” 124, “1Bar” 125, and “Blank” 126 is rearranged in any display cells during the free game, and the multiple number used to increase a payout during the free game is determined at random. In this example, a payout corresponding to a combination of four symbols “3Bar” 123 is multiplied by the determined multiple number and the resultant amount is awarded as a payout.

The plurality of background images different from those which are set for the basic game are displayed in the image display region 70 provided at part of the symbol matrix SM. As shown in FIG. 27B, the plurality of background images 130b are not displayed in combination making up the single complete image because the image 72 is displayed, in which the background images 130b on the third column are displayed so as to be misaligned by one frame. Therefore, the basic game is continued without execution of the free game.

FIGS. 28A and 28B are views each showing an exemplary image displayed in the slot machine shown in FIG. 20, during the free game. As shown in FIG. 25A, the upper image display panel 33 displays a free-game-number display image 99c indicative of the remaining number of times in executing the free game. Seven free games are executed in this example, so that the free-game-number display image 99c such as “3 FREE GAMES” is displayed, which indicates that three more free games remain, for example.

As shown in FIG. 28B, the symbol matrix SM is displayed in the display area section 92 of the lower image display panel 16, in which any combination of symbols “WILD” 121, “7” 122, “3Bar” 123, “2Bar” 124, “1Bar” 125, and “Blank” 126 is rearranged in any display cells of the symbol matrix SM.

The plurality of background images different from those which are set for the basic game are displayed in the image display region 70 provided at part of the symbol matrix SM. The display cells in the image display region 70 display the symbols, respectively. As shown in FIG. 28B, the single complete image is displayed in the image display region 70 in which the plurality of background images 130b are rearranged and displayed in the specific display cells, respectively. Therefore, the jackpot bonus game is to be executed.

The background images rearranged in the image display region 70 provided at part of the symbol matrix SM results in display of the single complete image during the free game, so that a jackpot display image 74 of “Jackpot!!”, which indicates that the jackpot bonus game is to be started, is displayed downwardly of the display area section 92.

Further, in a case where the plurality of background images 130b are displayed in combination making up the single complete image in the image display region 70, the display device is adjusted with respect to its display luminance so as to display the image display region 70 with relatively high luminance in whole or in part. Thus, the complete image is emphatically displayed in comparison to the symbol matrix SM. For example, as shown in FIG. 28B, a frame 71b in a different color from that of the frame 71, which is displayed upon display of the complete image during the basic game, is displayed with high luminance so as to be more emphasized than the symbol matrix SM.

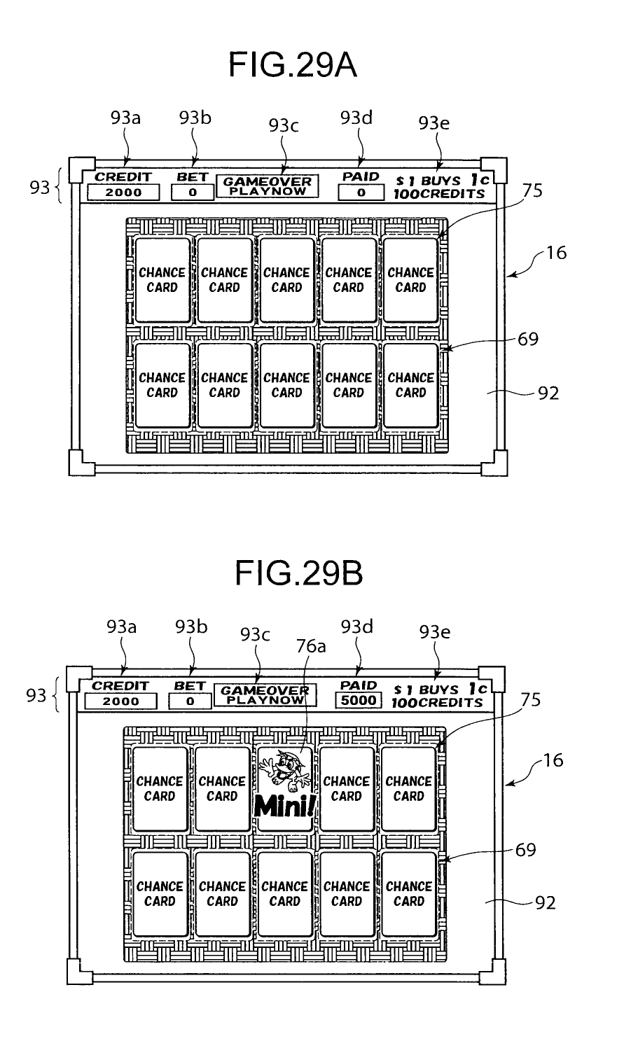

FIGS. 29A and 29B are views each showing an exemplary image displayed in the slot machine shown in FIG. 20, during the jackpot bonus game. As shown in FIG. 29A, the display area section 92 of the lower image display panel 16 displays card images 75 made up of ten face-down cards. The card images 75 are displayed such that a player can select one by operating the touch panel 69.

When a player selects one of the card images 75 by operating the touch panel 69 of FIG. 29A, the selected card image 75 is displayed in a face up manner. In a case where the player selects the third card image 75 from the left disposed on an upper row displayed in the display area section 92 of the lower image display panel 16, the selected card image 75 is displayed in a face up manner, and a payout card image 76a indicative of payout rank “Mini” as an outcome of the jackpot bonus game in the example case shown in FIG. 29B. Therefore, a payout corresponding to the rank “Mini” is to be awarded.

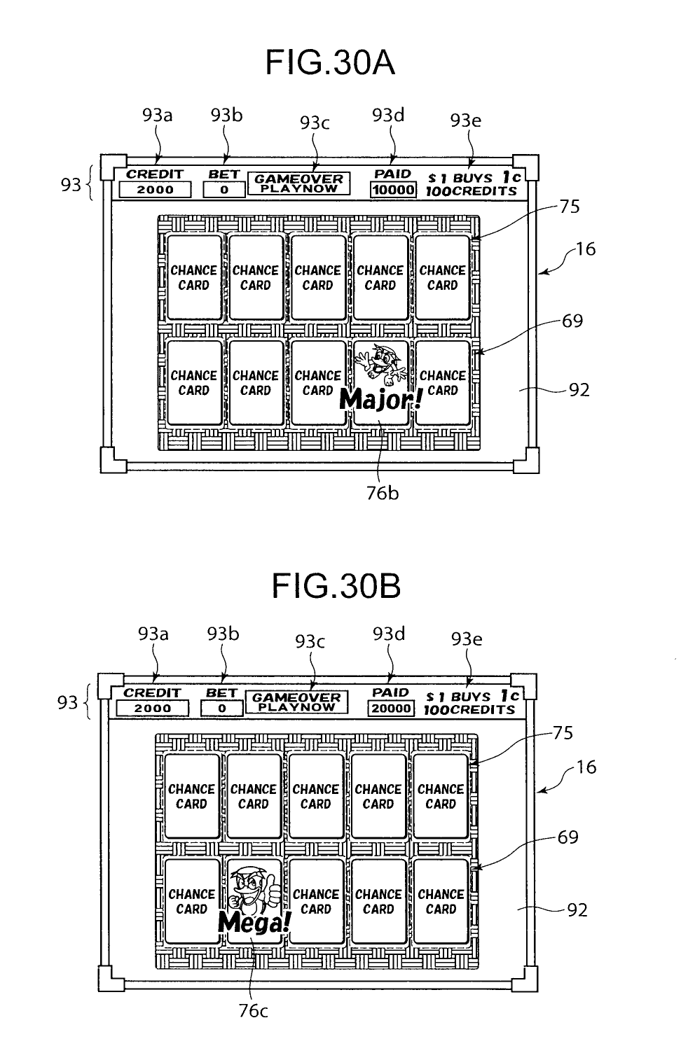

When the player selects one of the card images 75 by operating the touch panel 69 as shown in FIG. 29A, the selected card image 75 is displayed in a face up manner as shown in FIG. 30A. In a case where the second card image from the right disposed on a lower row displayed in the display area section 92 of the lower image display panel 16, the selected card image 75 is displayed in a face up manner, and a payout card image 76b indicative of payout rank “Major” as an outcome of the jackpot bonus game in the example case shown in FIG. 30A. Therefore, a payout corresponding to the rank “Major” is to be awarded.

When the player selects one of the card images 75 by operating the touch panel 69 as shown in FIG. 30A, the selected card image 75 is displayed in a face up manner as shown in FIG. 30B. In a case where the second card image from the left on the lower row displayed in the display area section 92 of the lower image display panel 16, the selected card image 75 is displayed in a face up manner, and a payout card image 76c indicative of payout rank “Mega” as an outcome of the jackpot bonus game in the example case shown in FIG. 30A. Therefore, a payout corresponding to the rank “Mega” is to be awarded.

Next, a process executed in the slot machine 10 according to this embodiment, will be described in detail with reference to the drawings. The main CPU 41 reads out and executes a game program, thereby conducting the game.

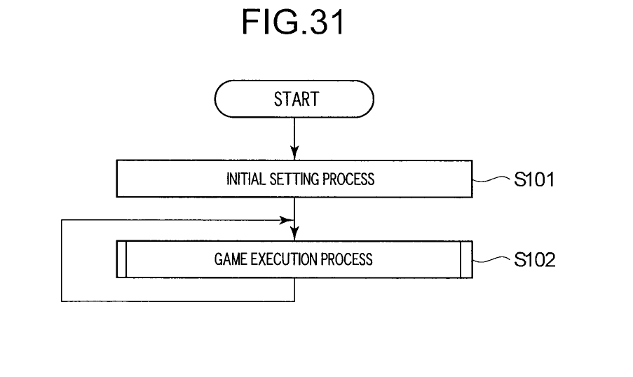

FIG. 31 is a flowchart showing a subroutine of the main process. In the main process, when a power switch is initially turned on (that is, when power is supplied), a motherboard 40 and a gaming board 50 are activated respectively, so that the CPU 51 executes an initial setting process (step S101). In this initial setting process, the main CPU 41 executes the BIOS stored in the ROM 42, decompresses, in the RAM 43, compressed data included in the BIOS, executes the BIOS decompressed in the RAM 43, and performs diagnosis and initialization of each of the peripheral devices. The main CPU 41 also performs an authentication process for each program during execution of the initial setting process.

Next, the main CPU 41 carries out a game execution process to be described later (step S102). In this game execution process, the main CPU 41 sequentially reads and executes the game programs or the like from the ROM 42. By performing this game execution process, the slot machine 10 executes the game according to this embodiment. The game execution process is repeatedly performed while power is supplied to the slot machine 10.

FIG. 32 is a flowchart showing a subroutine of game execution processing. This game execution process is carried out at step S102 of FIG. 31.

The main CPU 41 judges at step S201 whether or not a coin has been bet. Specifically, the main CPU 41 judges whether or not an input signal has been received, the signal being output from the 1-BET switch 26S when the 1-BET button 26 is pushed, or alternatively, being output from the max-BET switch 27S when the max-BET button 27 is pushed. In a case where the main CPU 41 judges that the coin has been bet (S201: YES), the routine proceeds to step S202. In a case where the main CPU 41 judges that the coin has not been bet (S201: NO), the routine returns to step S201.

Next, at step S202, the main CPU 41 subtracts the amount of bet coins from the credit amount stored in the RAM 43 upon judging at step S201 that the coin has been bet. In a case where the number of bet coins is greater than the credit amount stored in the RAM 43, the main CPU 41 controls the current step to return to step S201 without performing the process for subtracting the number of bet coins from the credit amount stored in the RAM 43. In a case where the number of bet coins exceeds the upper limit (fifty coins in this embodiment) of coins that can be bet in one game, the routine proceeds to step S203 without performing the process of subtracting the number of bet coins from the credit amount stored in the RAM 43.

Next, at step S203, the main CPU 41 judges whether or not the start button 23 has been set to ON. Specifically, the main CPU 41 judges whether or not an input signal has been received, the signal being output from the start switch 23S when the start button 23 is pushed. In a case where the main CPU 41 judges that the start button 23 has not been set to ON (step S203: NO), the routine returns to step S201. Where the start button 23 has not been set to ON (for example, where an instruction has been input to terminate the game without setting the start button 23 to ON), the main CPU 41 cancels acceptance of a subtraction result at step S202. On the other hand, in a case where the main CPU 41 judges that the start button 23 has been set to ON (S203: YES), the routine proceeds to step S204.

Next, upon judging at step S203 that the start button 23 has been set to ON (S203: YES), the main CPU 41 displays the plural types of symbols (background images) in a scrolling manner. Specifically, the main CPU 41 sequentially displays in a scrolling manner the plural types of symbols with the plurality of background images being as the backgrounds of the symbols, making up the single complete image, in the symbol matrix SM displayed on the lower image display panel 16.

Next, at step S205, the main CPU 41 determines a position in which the symbols are stopped. Specifically, the main CPU 41 executes the program stored in the RAM 43 and samples random numeric values in a numerical range which comes under a predetermined range of random numeric values. The main CPU 41 thus compares the sampled random numeric values with a range of random numeric values corresponding to the symbols, respectively, thereby determining at random the symbols to be rearranged in the symbol matrix SM displayed on the lower image display panel 16.

Next, at step S206, the main CPU 41 judges whether or not a prize has been established. Specifically, the main CPU 41 judges whether or not a predetermined number or more (for example, three or more) of symbols of the same type are rearranged in the symbol matrix SM. In a case where the main CPU 41 judges that the prize has been established (S206: YES), the routine proceeds to step S207. On the other hand, where the main CPU 41 judges that the prize has not been established (S206: NO), the routine proceeds to step S208.

Next, at step S207, upon judging that the prize has been established (step S206: YES), the main CPU 41 performs a coin-payout process in accordance with the bet amount and the amount of coins set for the number of symbols of the same type. In a case where coins are deposited, the main CPU 41 performs a process of adding the amount of coins to the credit amount stored in the RAM 43. On the other hand, in a case where coins are paid out, the main CPU 41 pays out the predetermined amount of coins by transmitting the control signal to the hopper 66.

Next, upon judging that any prize has not been established (S206: NO) or executing the payout process at step S207, the main CPU 41 judges at step S208 whether or not the background images, which are drawn as the background images of the plural types of symbols rearranged in the symbol matrix SM, are displayed in combination making up the single first complete image. For example, as shown in FIG. 22A, the main CPU 41 judges whether or not the plurality of background images are displayed in combination making up the single first complete picture in the symbol matrix SM. The routine proceeds to step S209 in a case where the main CPU 41 judges that the plurality of background images are displayed in combination making up the single first complete image (S208: YES). The execution is terminated in a case where the main CPU 41 judges that the plurality of background images are not displayed in combination making up the single first complete image (S208: NO).

Next, at step S209, upon judging that the plurality of background images are displayed in combination making up the single complete image (step S208: YES), the main CPU 41 emphatically displays the frame. Specifically, the main CPU 41 displays the frame 71a as shown in FIG. 22A and adjusts display luminance of the display area section 92 on the lower image display panel 16 to display the image display region 70 with relatively high luminance in whole or in part.

Next, at step S210, the main CPU 41 performs a free game execution process as the special prize. Herein, the main CPU 41 reads and executes game programs or the like out of the ROM 42, thereby performing the free game process.

FIG. 33 is a flowchart showing a subroutine of the free game execution process.

At step S602, the main CPU 41 determines symbol arrays for use in the second to fourth columns. Specifically, the main CPU 41 executes the program stored in the RAM 43 to sample random numeric values in a numerical range which comes under a predetermined range of random numeric values. The main CPU 41 then compares the sampled random numeric values with a range of random numeric values correlated with the symbol arrays, thereby determining the symbol arrays at random. Herein, any one of the symbol arrays shown in FIGS. 23A to 23C is determined at random as those which is used on the second column. Any one of the symbol arrays shown in FIGS. 24A to 24C is determined at random as those which is used on the third column. Any one of the symbol arrays shown in FIGS. 25A to 25C is determined at random as those which is used on the fourth column.

Next, at step S402, the main CPU 41 sets the number of times in executing the free game number, i.e., the free game number T. Specifically, the main CPU 41 executes the program stored in the RAM 43, thereby reading the free game number T that is set in association with a random number using a random numeric value sampled in a numerical range which comes under a predetermined range of random numeric values 1 to 256. After that, the main CPU 41 determines the free game number T.

Next, at step S403, the main CPU 41 sets the free game number B to T. Specifically, the main CPU 41 sets a remaining free game number B=T in the storage area that is provided in the RAM 43 and stores the data indicative of the remaining free game number B. A value of T is equal to the free game number T determined at step S402.

Next, at step S404, the main CPU 41 then judges whether or not the start button 23 has been set to ON. Specifically, the main CPU 41 judges whether or not an input signal has been received, the signal being output from the start switch 23S when the start button 23 is pushed. The routine returns to step S404 in a case where the main CPU 41 judges that the start button 23 has not been set to ON (step S404: NO). The routine proceeds to step S405 in a case where the main CPU 41 judges that the start button has been set to ON (Step S404: YES).

Next, at step S405, the main CPU 41 performs an effect image displaying process. Specifically, the main CPU 41 displays the free game number display images 90a to 90c corresponding to the free game number on the upper image display panel 33 (see FIGS. 26 to 28).

Next, at step S406, the main CPU 41 performs a symbol rearrangement process. Specifically, the main CPU 41 executes the program stored in the RAM 43 to sample random numeric values in a numerical range which comes under a predetermined range of random numeric values. The main CPU 41 then compares the sampled random numeric values with a range of random numeric values correlated with the symbols, thereby determining at random the symbols rearranged in the symbol matrix SM displayed on the lower image display panel 16. The main CPU 41 then performs a symbol scroll-display stopping process based on the determined symbols.

Next, at step S407, the main CPU 41 judges whether or not the prize has been established. Specifically, the main CPU 41 judges whether or not the predetermined number (for example, three) or more of symbols of the same type are rearranged in the symbol matrix SM. Upon judging that the prize has been established (S407: YES), the main CPU 41 calculates a payout corresponding to the amount set for the number of symbols and the bet amount. The above calculation of a payout is not limitative and includes calculation such that a predetermined multiple number (for example, three) is previously determined at random, and a payout is calculated by the expression of (3×bet amount)×3 in a case where three symbols of the same type are displayed in a stopped state.

Next, at step S408, the main CPU 41 performs a coin payout process based on the payout determined at step S407 by the calculation. In a case where coins are deposited, the main CPU 41 performs a process of adding the amount of coins to the credit amount stored in the RAM 43. On the other hand, in a case where coins are paid out, the main CPU 41 pays out the predetermined amount of coins by transmitting the control signal to the hopper 66.

Upon judging that the prize has not been established (S407: NO) or executing the payout process at step S408, the main CPU 41 judges at step S409 whether or not the plurality of background images are displayed in combination making up the complete image (the second complete image). Specifically, as shown in FIG. 28B, the main CPU 41 judges whether or not the plurality of background images drawn as the backgrounds of the rearranged symbols are displayed in combination making up the single second complete image on the second to fourth symbol arrays that have been determined at random as described above. In a case where the main CPU 41 judges that the plurality of background images are displayed in combination making up the single second complete image (S409: YES), the routine proceeds to step S410. In a case of judgment that the plurality of background images are not displayed in combination making up the single second complete image (S409: NO), the routine proceeds to step S412. Incidentally, in a case where the plurality of background images are displayed in combination making up the single second complete image during the free game, the game enters into the progressive jackpot bonus game.

Next, upon judging that the plurality of background images are displayed in combination making up the single second complete image (S409: YES), the main CPU 41 displays a frame so as to improve the visibility of the complete image. Specifically, the main CPU 41 displays the image display region 70 with relatively high luminance in whole or in part. For example, as shown in FIG. 28B, the second complete image in combination is emphatically displayed in comparison to the symbol matrix SM by displaying the frame 71 with high luminance.

Next, at step S411, the main CPU 41 performs a jackpot bonus game execution process. In this case, the main CPU 41 sequentially reads out and executes the game programs or the like from the ROM42 to execute the jackpot bonus game execution process.

Next, at step S412, the main CPU 41 sets the remaining number of times in executing the free game, i.e., the remaining free game number to B=B−1. Specifically, the main CPU 41 sets B=B−1 at a value of the remaining free game number B stored in the RAM 43, upon judging that the plurality of background images are not displayed in combination making up the single second complete image (S409: NO) and upon executing the progressive jackpot bonus game execution process at step S411.

Next, at step S413, the main CPU 41 then judges whether or not a value of the remaining free game number B is equal to zero. Specifically, the main CPU 41 judges whether or not a value of the remaining game number B stored in the RAM43 is equal to zero. In a case of judgment that a value of the remaining free game number B is not equal to zero (step S413: NO), the routine returns to step S404. On the other hand, upon judging that a value of B is equal to zero (step S413: YES), the main CPU 41 terminates the free game execution process.

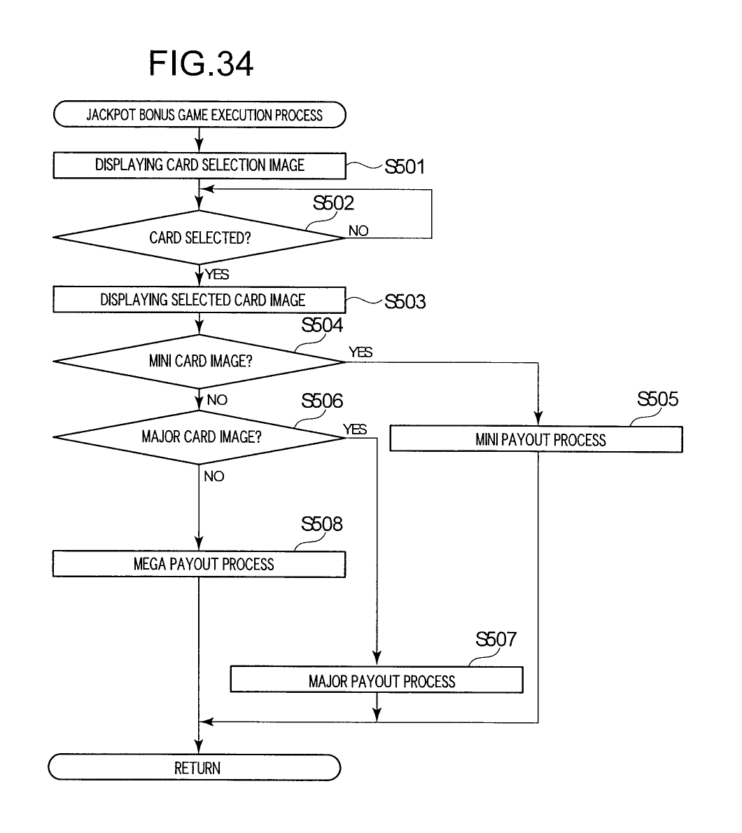

FIG. 34 is a flowchart showing a subroutine of the jackpot bonus game execution process.

First, the main CPU 41 displays a card selection image at step S501. Specifically, the main CPU 41 determines a payout rank of the progressive jackpot bonus game by executing the program stored in the RAM 43. The main CPU 41 samples the random numeric values in a numerical range which comes under a predetermined range of random numeric values, and compares the sampled random numeric values with a range of random numeric values correlated with each payout rank (“Mini”, “Major”, and “Mega”). The main CPU 41 determines each payout rank in a correlation with each of ten cards. When a player selects one card by operating the touch panel 69, the main CPU 41 displays a payout rank of the progressive jackpot bonus game that is determined as a rank correlated with the selected card. For example, as shown in FIG. 29A, the main CPU 41 displays the card image 75 made up often face-down cards on the display area section 92 of the lower image display panel 16.

Next, at step S502, the main CPU 41 judges whether or not a player selects a card. Specifically, the main CPU 41 judges whether or not the player selects the single card image 75 by means of the touch panel 69. In a case where the main CPU 41 judges that the card has not been selected (S502: NO), the routine returns to step S502. In a case of judgment that the card has been selected (S502: YES), the routine proceeds to step S503.

Next, the main CPU 41 displays the selected card image at step S503 upon judging that the card has been selected (S502: YES). Specifically, the main CPU 41 displays the card image 75 selected by the player, in a face up manner, as shown in FIGS. 29B, 30A, and 30B.

Next, at step S504, the main CPU 41 judges whether or not a card image “Mini” has been displayed. Specifically, the main CPU 41 judges whether or not the card image 75 displayed at step S503 represents “Mini”.

Next, upon judging that the card image “Mini” (S504: YES), the main CPU 41 executes a “Mini” payout process at step S505. Specifically, the main CPU 41 executes a coin payout process corresponding to a “Mini” payout. Upon executing the process at step S505, the main CPU 41 terminates the jackpot bonus game execution process.

Next, the main CPU 41 judges whether or not a card image “Major” has been displayed at step S506 upon judging that the card image “Mini” has not been displayed (S504: NO). Specifically, the main CPU 41 judges whether or not the card image 75 displayed as step S503 represents “Major”.

Next, the main CPU 41 executes a “Major” payout process at step S507 upon judging that the card image “Major” has been displayed (S506: YES). The main CPU 41 terminates the jackpot bonus game execution process when executing the process at step S507.

Next, the main CPU 41 executes a “Mega” payout process at step S508 upon judging that the card image “Major” has not been displayed (S506: NO). Specifically, the main CPU 41 executes a coin payout process corresponding to a “Mega” payout. The main CPU 41 terminates the jackpot bonus game execution process when executing the process at step S508.

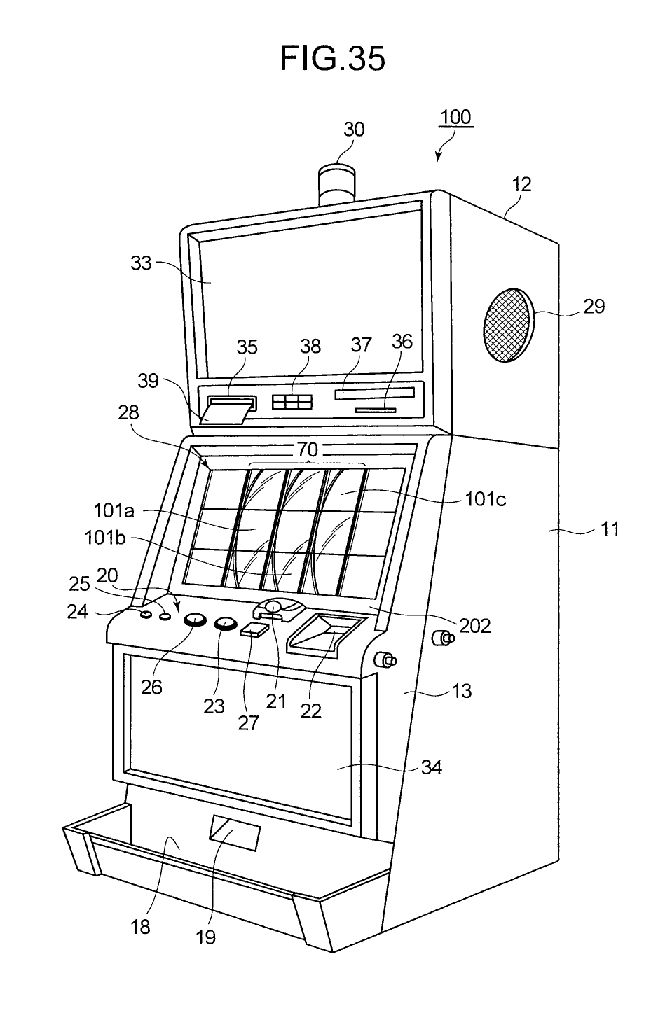

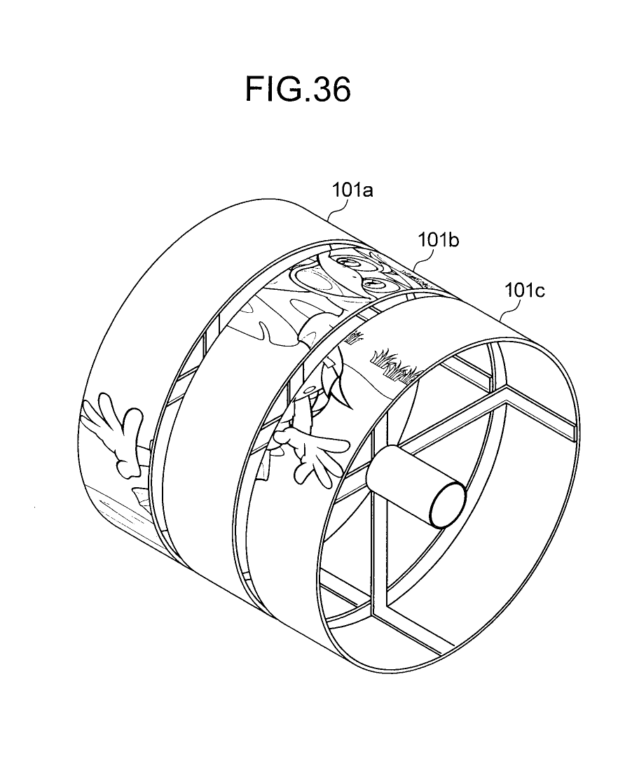

Next, a slot machine 100 according to another embodiment will be described with reference to FIGS. 35 and 36. The slot machine according to another embodiment below is a so-called hybrid slot machine in which a plurality of rotatably-supported mechanical reels have a transparent liquid crystal panel on front surfaces to display images drawn on peripheral surfaces of the mechanism reels through the transparent liquid crystal panel. Explanation for the similar structure is omitted and the same structure is explained with the same reference numerals between the slot machine 100 and the slot machine 10 according to the embodiment of the present invention described above.

FIG. 35 is a perspective view schematically showing a frame format of the slot machine according to the aforementioned another embodiment of the present invention. As shown in FIG. 35, the slot machine 100 is rotatably provided with three reels 101a to 101c. The plurality of background images, which make up the single complete image, are drawn on each of the peripheral surfaces of the reels 101a to 101c, as shown in FIG. 36.

A main liquid crystal panel 202 formed of a transparent liquid crystal panel, which is disposed at the main door 13, is provided in front of the respective reels 101a to 101c. The main liquid crystal panel 202 displays the symbol display region 28 that allows each of the reels 101a to 101c to be visually recognizable. A total of fifteen symbols in five columns and three rows are rearranged in the symbol display region 28.

Any combination of symbols “WILD” 121, “7” 122, “3Bar” 123, “2Bar” 124, “1Bar” 125, and “Blank” 126 is rearranged in the symbol display region 28, and a payout is awarded based on a combination and the number of symbols rearranged in the symbol matrix SM.

The game enters into the free game as the special prize in a case where the plurality of background images displayed as the backgrounds of the plural types of symbols are displayed in combination making up the single complete image (the first complete image) in the image display region 70 during the basic game.

The game enters into the progressive jackpot bonus game as a special payout in a case where the plurality of background images displayed as backgrounds of the plural types of symbols are displayed in combination making up the single complete image (the second complete image) in the image display region 70 during the free game.

While the above embodiments described a case in which a multiple number is randomly determined at the time of start of the free game so as to award a payout when the symbols are rearranged in a predetermined combination during the free game, by multiplying a payout corresponding to the predetermined combination by the determined multiple number, the present invention is not limitative thereto. The multiple number may be randomly determined every time the start button 23 is pushed during the free game.

While the above embodiments described a case in which the frame 71 surrounding the image display region 70 is displayed when the plurality of background images are displayed in combination making up the single complete image, the present invention is not limitative thereto. The image display region 70 may be emphatically displayed by displaying the symbol matrix SM with areas other than the image display region 70 being in a non-transparent state.

While the embodiment according to the present invention has been described, the description presents only some of the specific examples and is not intended to limit the present invention in any way and specific constructions of each means and the like can be properly changed in terms of design. Moreover, the effects described in the embodiment of the present invention are only the most preferable effects generated from the present invention and the effects to be caused by the present invention is not limitative thereto.

What is claimed is:

1. A slot machine, comprising:
(i) a display device for displaying plural types of symbols and a plurality of partial pieces making up a single picture drawn as a background of the symbols;
(ii) a memory for storing image data concerning the plurality of pieces making up a first picture, and image data concerning the plurality of pieces making up a second picture; and
(iii) a controller, the controller being programmed to:
(a) determine the plural types of symbols to be rearranged on the display device;
(b) read out of the memory, the plural types of symbols and the image data concerning the plurality of pieces making up the first picture, according to a result of the determination in the itemized (a);
(c) rearrange on the display device, the plural types of symbols read out in the itemized (b), and the image data concerning the plurality of pieces making up the first picture drawn as the background of the symbols;
(d) award a payout based upon a predetermined combination, in a case where a judgment that the symbols rearranged on the display device establish the predetermined combination is made as a result of the itemized (c);
(e) determine winning establishment of a special prize, in a case where a judgment that the plurality of pieces drawn as the background of the symbols rearranged on the display device are combined with one another on the display device to make up the first picture is made as a result of the itemized (c);
(f) read out of the memory, the plural types of symbols and the image data concerning the plurality of pieces making up the second picture; and
(g) rearrange on the display device, the plural types of symbols read out in the itemized (f), and the image data concerning the plurality of pieces making up the second picture drawn as the background of the symbols.

2. The slot machine according to claim 1, wherein:
the controller is further programmed to:
rearrange on the display device in the itemized (c), the plural types of symbols and the image data concerning the plurality of pieces making up the first picture so as to variably display in a first direction, a symbol array having the plurality of pieces making up the first picture drawn as the background of the plural types of symbols;
rearrange on the display device in the itemized (g), the plural types of symbols and the image data concerning the plurality of pieces making up the second picture so as to variably display in a second direction, a symbol array having the plurality of pieces drawn as the background of the plural types of symbols;
determine type of the special prize in accordance with the second picture, in a case where a judgment that the plurality of pieces making up the second picture rearranged on the display device are combined with one another on the display device to make up the second picture is made; and
execute a process of awarding the determined special prize.

3. The slot machine according to claim 1, wherein:
processes in the itemized (f) and (g) are executed during the special prize determined in the itemized (e); and
the controller is further programmed to award a special payout in a case where a judgment that the plurality of pieces making up the second picture drawn as the background of the symbols are combined with one another on the display device to make up the second picture is made as a result of repeated execution of the itemized (f) and (g) during the special prize.

4. A slot machine, comprising:
(i) a display device for displaying plural types of symbols and a plurality of partial pieces making up a single picture drawn as a background of the symbols;
(ii) a memory for storing image data concerning the plurality of pieces making up a first picture intended for determining winning establishment of a special prize, and image data concerning the plurality of pieces making up a second picture intended for determining type of the special prize; and
(iii) a controller, the controller being programmed to:
(a) read out of the memory, the image data concerning the plurality of pieces making up the first picture;
(b) variably display in a first direction, a symbol array having at least one of the plurality of pieces drawn as the background of the symbols;
(c) award a payout based upon a predetermined combination, in a case where a judgment that the symbols rearranged on the display device establish the predetermined combination is made as a result of the itemized (b);
(d) determine the winning establishment of the special prize, in a case where a judgment that the plurality of pieces drawn as the background of the symbols rearranged on the display device are combined with one another on the display device to make up the first picture is made as a result of the itemized (b);
(e) read out of the memory, the image data concerning the plurality of pieces making up the second picture;
(f) variably display in a second direction different from the first direction, a plurality of symbol arrays having the plurality of pieces drawn thereon;
(g) determine the type of the special prize in accordance with the second picture, in a case where a judgment that the plurality of pieces rearranged on the display device are combined with one another on the display device to make up the second picture is made as a result of the itemized (f); and
(h) execute a process of awarding the special prize based upon the special prize of the type determined in the itemized (g).

5. The slot machine according to claim 4, wherein:
the second picture is made up of a plurality of pictures in accordance with the type of the special prize.

6. The slot machine according to claim 4, wherein:
the controller executes a process in the itemized (f) such that the plurality of pieces making up the second picture are drawn in at least three or more symbol arrays.

7. The slot machine according to claim 4, wherein:
the controller adjusts luminance of the display device so as to display with relatively high luminance a region of the display device in which the second picture is arranged, in a case where a judgment that the plurality of pieces are combined with one another on the display device to make up the second picture is made in the itemized (g).

8. A slot machine, comprising:
(i) a display device for displaying plural types of symbols and a plurality of background images which are drawn as backgrounds of the symbols and make up a single complete image; and
(ii) a controller, the controller being configured to:
(a) determine the plural types of symbols to be rearranged on the display device;
(b) rearrange on the display device, the plural types of symbols determined in the itemized (a) and the plurality of background images drawn as the backgrounds of the symbols;
(c) award a payout based on the symbols rearranged on the display device, in a case where the symbols form a predetermined combination as a result of the itemized (b);
(d) judge whether or not the plurality of background images drawn as the backgrounds of the symbols that have been rearranged on the display device as a result of the itemized (b) are displayed in combination making up the single complete image;
(e) execute a special game as a special prize, in a case where a judgment is made as a result of the itemized (d), that the plurality of background images drawn as the backgrounds of the symbols make up the single complete image; and
(f) award a special payout, in a case where a judgment is made as a result of the itemized (a) to (d) processed during the special game executed in the itemized (e), that the plurality of background images drawn as the backgrounds of the symbols are displayed in combination making up the single complete image on the display device.

9. The slot machine according to claim 8, further comprising an image memory for storing the plurality of background images making up a first complete image and the plurality of background images making up a second complete image, wherein:
the controller:
reads out the plurality of background images making up the first complete image from the image memory;
displays the read-out plurality of background images making up the first complete image, as the backgrounds of the symbols, in the itemized (b) to (e);
reads out the plurality of background images making up the second complete image from the image memory; and
displays the read-out plurality of background images making up the second complete image, as the background of the symbols, in the itemized (f).

10. The slot machine according to claim 8, wherein:
the controller, in a case where the plurality of background images are displayed in combination making up the single complete image on the display device in the itemized (f):
randomly determines rank of the special payout; and
awards the special payout based on the determined rank.

11. The slot machine according to claim 8, wherein:
the controller, in the itemized (f):
randomly determines a predetermined multiple number to increase a payout during the special game; and
awards the payout based on the predetermined multiple number, in a case where the symbols rearranged on the display device form a predetermined combination.

12. The slot machine according to claim 8, wherein:
the controller, in the itemized (e) and (f), adjusts display luminance of the display device to display with relatively high luminance a region of the display device in which the single complete image is displayed, in a case where the plurality of background images are displayed in combination making up the single complete image on the displace device.
